(19) United States
(12) Patent Application Publication
(10) Pub. No.: US 2024/0406912 A1
(43) Pub. Date: Dec. 5, 2024

(54) DETERMINING A TARGET-UE POSITION BASED ON AN ARCHITECTURE TYPE

(71) Applicant: Lenovo (Singapore) Pte. Ltd., New Tech Park (SG)

(72) Inventors: Robin Thomas, Bad Nauheim (DE); Sher Ali Cheema, Ilmenau (DE); Majid Ghanbarinejad, Chicago, IL (US)

(21) Appl. No.: 18/694,825

(22) PCT Filed: Sep. 22, 2022
(86) PCT No.: PCT/IB2022/058994

§ 371 Date: Mar. 22, 2024

Related U.S. Application Data
(60) Provisional application No. 63/247,304, filed on Sep. 22, 2021.
(60) Provisional application No. 63/247,307, filed on Sep. 23, 2021.

(51) Int. Cl. H04W 64/00; H04W 28/02; H04W 84/06

(52) U.S. Cl. CPC H04W 64/00; H04W 28/0268; H04W 84/06

(57) ABSTRACT

Apparatuses, methods, and systems are disclosed for location services in a non-terrestrial networks (“NTN”). One method includes configuring a plurality of location services for a UE over an NTN NG-RAN that comprises at least one satellite and at least one NTN gateway. The method includes determining an architecture type of the NTN NG-RAN and determining a target-UE position estimate based on the determined architecture type.

### CROSS-REFERENCE TO RELATED APPLICATIONS

This application claims priority to United States Provisional Patent Application No. 63/247,304 entitled “LOCATION SERVER ARCHITECTURAL ENHANCEMENTS FOR NON-TERRESTRIAL NETWORKS” and filed on 22 Sep. 2021 for Robin Thomas, Sher Ali Cheema, and Majid Ghanbarinejad, which application is incorporated herein by reference. This application also claims priority to U.S. Provisional Patent Application No. 63/247,307 entitled “LOCATION SERVER ARCHITECTURAL ENHANCEMENTS FOR NON-TERRESTRIAL NETWORKS” and filed on 23 Sep. 2021 for Robin Thomas, Sher Ali Cheema, and Majid Ghanbarinejad, which application is incorporated herein by reference.

### FIELD

The subject matter disclosed herein relates generally to wireless communications and more particularly relates to location server architectural enhancements for non-terrestrial networks (“NTNs”).

### BACKGROUND

In certain wireless communication systems, Radio Access Technology (“RAT”) dependent positioning using Third Generation Partnership Project (“3GPP”) New Radio (“NR”) technology has been recently supported in Release 16 of the 3GPP specifications. The positioning features include Fifth Generation (“5G”) network core architectural and interface enhancements, as well as Radio Access Node (“RAN”) functionality that support Layer-1 (“L1”), Layer-2 (“L2”) and/or Layer-3 (“L3”) signaling procedures to enable RAT-dependent NR Positioning.

### BRIEF SUMMARY

Disclosed are procedures for location services in NTN. Said procedures may be implemented by apparatus, systems, methods, or computer program products.

One method at a mobile communication network includes configuring a plurality of location services for a User Equipment (“UE”) over a non-terrestrial network (“NTN”) next generation-radio access network (“NG-RAN”) that comprises at least one satellite and at least one NTN gateway. The first method includes determining an architecture type of the NTN NG-RAN and determining a target-UE position estimate based on the determined architecture type.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for location services in NTN;

FIG. 2 is a block diagram illustrating one embodiment of a 5G NR protocol stack;

FIG. 3 is a diagram illustrating one embodiment of NR downlink (“DL”)-based positioning;

FIG. 4 is a diagram illustrating one embodiment of Downlink Time Different of Arrival (“DL-TDOA”) assistance data;

FIG. 5A is a diagram illustrating one embodiment of a DL-TDOA measurement report;

FIG. 5B is a continuation of the DL-TDOA measurement report of FIG. 5A;

FIG. 6A is a diagram illustrating one embodiment of location service support by the NG-RAN;

FIG. 6B is a diagram illustrating one embodiment of a gNB split architecture for the NG-RAN;

FIG. 7 is a diagram illustrating one embodiment of location service support by NG-RAN;

FIG. 8 is a diagram illustrating one embodiment of networking-RAN architecture with transparent satellite;

FIG. 9 is a diagram illustrating one embodiment of transport-satellite based NG-RAN with mapping to Quality of Service (“QoS”) flows;

FIG. 10 is a diagram illustrating one embodiment of a User Plane protocol stack for a transparent satellite;

FIG. 11 is a diagram illustrating one embodiment of a Control Plane protocol stack for a transparent satellite;

FIG. 12 is a diagram illustrating one embodiment of a regenerative satellite without Inter-Satellite Link (“ISL”) 5G/NR Node B (“gNB”) processed payload;

FIG. 13 is a diagram illustrating one embodiment of a regenerative satellite with ISL gNB processed payload;

FIG. 14 is a diagram illustrating one embodiment of regenerative satellite-based NG-RAN architecture with QoS flows;

FIG. 15 is a diagram illustrating one embodiment of a User Plane protocol stack for a regenerative satellite;

FIG. 16 is a diagram illustrating one embodiment of a Control Plane protocol stack for a regenerative satellite;

FIG. 17A is a diagram illustrating a first embodiment of positioning architecture based on the same Location Management Function (“LMF”) using transparent NTN system;

FIG. 17B is a diagram illustrating a second embodiment of positioning architecture based on same LMF using transparent NTN system;

FIG. 17C is a diagram illustrating a third embodiment of positioning architecture based on same LMF using transparent NTN system;

FIG. 17D is a diagram illustrating a fourth embodiment of positioning architecture based on same LMF using transparent NTN system;

FIG. 18A is a diagram illustrating first embodiment of positioning architecture based on same LMF using regenerative NTN system;

FIG. 18B is a diagram illustrating second embodiment of positioning architecture based on same LMF using regenerative NTN system;

FIG. 18C is a diagram illustrating third embodiment of positioning architecture based on same LMF using regenerative NTN system;

FIG. 18D is a diagram illustrating fourth embodiment of positioning architecture based on same LMF using regenerative NTN system;

FIG. 19A is a diagram illustrating first embodiment of a positioning architecture based on serving and neighboring LMF using transparent NTN system;

FIG. 19B is a diagram illustrating second embodiment of a positioning architecture based on serving and neighboring LMF using transparent NTN system;

FIG. 19C is a diagram illustrating third embodiment of a positioning architecture based on serving and neighboring LMF using transparent NTN system;

FIG. 20A is a diagram illustrating one embodiment of a positioning architecture based on serving and neighboring LMF using regenerative NTN system;

FIG. 20B is a diagram illustrating one embodiment of a positioning architecture based on serving and neighboring LMF using regenerative NTN system;

FIG. 21 is a diagram illustrating one embodiment of a positioning architecture with Location Management Component (“LMC”) as part of gNB for regenerative NTN system;

FIG. 22 is a diagram illustrating one embodiment of a first positioning architecture with LMC connected to NTN gateway for regenerative NTN system;

FIG. 23 is a diagram illustrating one embodiment of a second positioning architecture with LMC connected to NTN gateway for regenerative NTN system;

FIG. 24 is a block diagram illustrating one embodiment of a user equipment apparatus that may be used for location service in NTN;

FIG. 25 is a block diagram illustrating one embodiment of a network apparatus that may be used for location service in NTN; and

FIG. 26 is a flowchart diagram illustrating one embodiment of a first method for location service in NTN.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for location service in NTN. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A key issue to address for NTN is to enable a compatible NG-RAN LoCation Service (“LCS”) framework including signaling support for RAT-independent and RAT-dependent positioning methods for target UEs connected to a non-terrestrial based network. The present disclosure provides a set of NG-RAN architectural enhancements to enable integration of LCS services in the current 3GPP NTN framework. The key challenges are outlined as follows:

There currently exists no specified interfaces and signaling options that integrate the NTN architecture into the current 3GPP positioning framework. In order to fulfill the regulatory and emergency services, it is important any triggered LCS request from the UE or external LCS client can be fulfilled by an NTN compatible solution.

There are currently no specified 3GPP interfaces and architecture options involving the gateway and low earth orbit (“LEO”) satellites for performing positioning, which is different to the current RAT-independent methods that include medium earth orbit (“MEO”) global navigation satellite system (“GNSS”) solutions such as Global Positioning System (“GPS”), GLObal'naya NAvigatsionnaya Sputnikovaya Sistema (“GLONASS”), etc. The challenge in such NTN operational scenarios is to integrate the existing LMF architecture to support the different positioning methods.

According to a first solution, NG-RAN LCS is supported over transparent-payload NTN deployments by providing single- and multi-connectivity NG-RAN architecture.

According to a second solution, NG-RAN LCS is supported over regenerative-payload NTN deployments by providing single- and multi-connectivity NG-RAN architecture.

According to a third solution, UE-based positioning (i.e., where target-UE position is calculated within the UE) and network-based positioning (i.e., where target-UE position is calculated in the LMC and/or LMF) is supported by enabling different types of location requests to be triggered over an NTN NG-RAN architecture. As used herein, the “target-UE” refers to the UE that is the focus (i.e., target) of the positioning/location service.

According to a fourth solution, enhanced location procedures (including configuration, measurement, and reporting) are supported by providing an indication to LMF regarding different NTN architectural options.

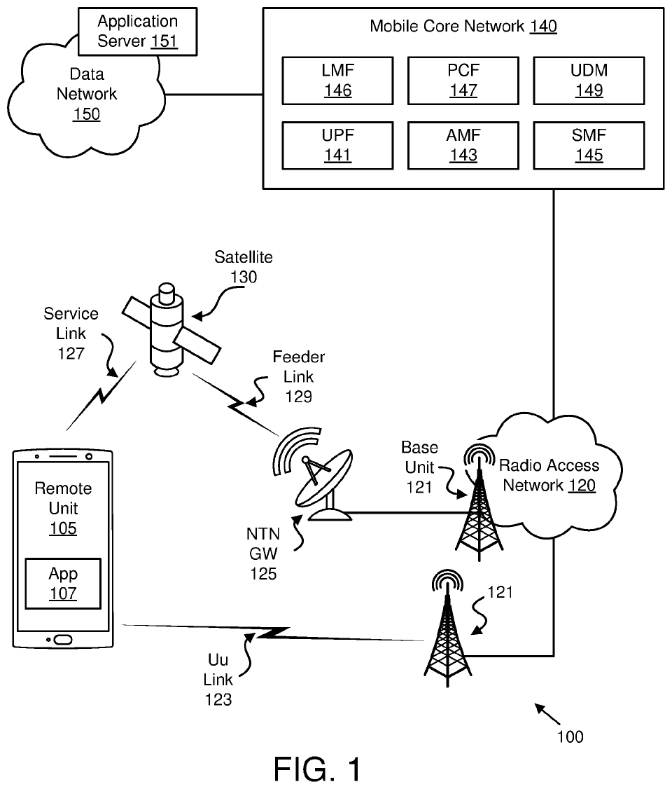

FIG. 1 depicts a wireless communication system 100 for location services in NTN, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a Terrestrial Network (“TN”) and/or an NTN. The TN portion of the RAN 120 may be composed of a base unit 121 with which the at least one remote unit 105 communicates using wireless communication links 123. The NTN portion of the RAN 120 may be composed of a non-terrestrial network gateway (“NTN GW”) 123 with which the remote unit 105 communicates via a satellite 130 using wireless communication links, e.g., service link(s) 125 and feeder link(s) 127. As depicted, the mobile communication network includes an “on-ground” base unit 121 and NTN GW 123 which serves the remote unit 105 via satellite access.

Even though a specific number of remote units 105, base units 121, wireless communication links 123, RANs 120, NTN GWs 125, satellites 130, and mobile core networks 140 are depicted in FIG. 1, one of skill in the art will recognize that any number of remote units 105, base units 121, wireless communication links 123, RANs 120, NTN GWs 125, satellites 130, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”), such as a universal integrated circuit card (“UICC”), and a ME providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. In some embodiments, the remote units 105 communicate in a non-terrestrial network via UL and DL communication signals between the remote unit 105 and a satellite 130. In certain embodiments, the satellite 130 may communicate with the RAN 120 via an NTN GW 125 using UL and DL communication signals between the satellite 130 and the NTN GW 125. The NTN GW 125 may communicate directly with the base units 121 in the RAN 120 to relay UL and DL communication signals.

Furthermore, the UL and DL communication signals may be carried over the wireless communication links 123. In the depicted embodiment, the wireless communication link between the remote unit 105 and satellite 130 comprises a service link 125, while the wireless communication link between the satellite 130 and the NTN GW 125 comprises a feeder link 127. However, in other embodiments, the satellite(s) 130 and NTN GW(s) 125 may be deployed between the base unit 121 or RAN 120 and the mobile core network 140, e.g., similar to wireless backhaul links. In yet other embodiments

The RAN 120 is an intermediate network that provides the remote unit(s) 105 with access to the mobile core network 140. Moreover, the satellite 130 provides a non-terrestrial network allowing the remote unit 105 to access the mobile core network 140 via satellite access. While FIG. 1 depicts a transparent NTN system where the satellite 130 repeats the waveform signal for the base unit 121, in other embodiments the satellite 130 (for regenerative NTN system), or the NTN gateway 123 (for alternative implementation of transparent NTN system) may also act as base station, depending on the deployed configuration. Thus, in certain embodiments, all or a portion of the base unit 121 may embodied in the satellite(s) 130 or the NTN GW(s) 125.

Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). In the following, an UL transmission may refer to a PUSCH transmission, a PUCCH transmission, Random Access Channel (“RACH”) transmission, and/or an UL signaling. Moreover, a DL transmission may refer to a PDSCH transmission, a PDCCH transmission, or other DL signaling.

In various embodiments, the remote units 105 may communicate directly with each other (e.g., device-to-device communication) using sidelink communication (not shown in FIG. 1). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time-units (e.g., Orthogonal Frequency Division Multiplexing (“OFDM”) symbols, subframe, slots, subslots, etc.). In some embodiments, the set of resource blocks comprises contiguous PRBs in the frequency domain. A PRB, as used herein, consists of twelve consecutive subcarriers in the frequency domain. It should be mentioned that throughout the disclosure, the terms symbol, slot, subslot and transmission time interval (“TTI”) refers to a time unit with a particular duration (e.g., symbol could be a fraction/percentage of an OFDM symbol length associated with a particular subcarrier spacing (“SCS”)).

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more QoS Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a gNB, a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals and receive UL communication signals to serve the remote units 105 in the time, frequency, and/or spatial domain. Furthermore, the DL and UL communication signals may be carried over the wireless communication links 123, e.g., over a Uu interface. The wireless communication links 123 may be any suitable carrier in licensed or unlicensed radio spectrum. The wireless communication links 123 facilitate communication between one or more of the remote units 105 and/or one or more of the base units 121.

To facilitate cell access, the RAN 120 transmits (e.g., periodically) a synchronization signal (e.g., primary synchronization signal and secondary synchronization signal) and Physical Broadcast Channel (“PBCH”), which comprise a synchronization signal block (“SSB”). For example, each base unit 121 in the RAN 120 may transmit a set of SSB. The periodicity, number repetitions, time-domain location/offset, and other parameters of the SSB may depend on the carrier frequency and subcarrier spacing (“SCS”) of the cell. The remote unit 105 uses the information in the SSB to access a particular cell using a single-carrier waveform, e.g., by transmitting a connection request to a respective base unit 121 supporting the particular cell.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 142 that serves the RAN 120, a Session Management Function (“SMF”) 143, a Policy Control Function (“PCF”) 144, a Network Exposure Function (“NEF”) 145, an Location Management Function (“LMF”) 146, a Policy Control Function (“PCF”) 147, a UDM and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The LMF 146 receives measurements and assistance information from the RAN 120 and the remote unit 105 via the AMF 143 over the ‘NLs’ interface to determine the location/position of the remote unit 105. In some embodiments, the LMF 146 configures the remote unit 106 via the AMF 143. The RAN 120 configures the remote unit 105 using radio resource control (“RRC”) protocol over the Uu interface (e.g., LTE-Uu and/or NR-Uu). The PCF 147 is responsible for unified policy framework, providing policy rules to CP functions, access subscription information for policy decisions in UDR. The PCF 147 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third-party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for location services in NTN apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for location services in NTN.

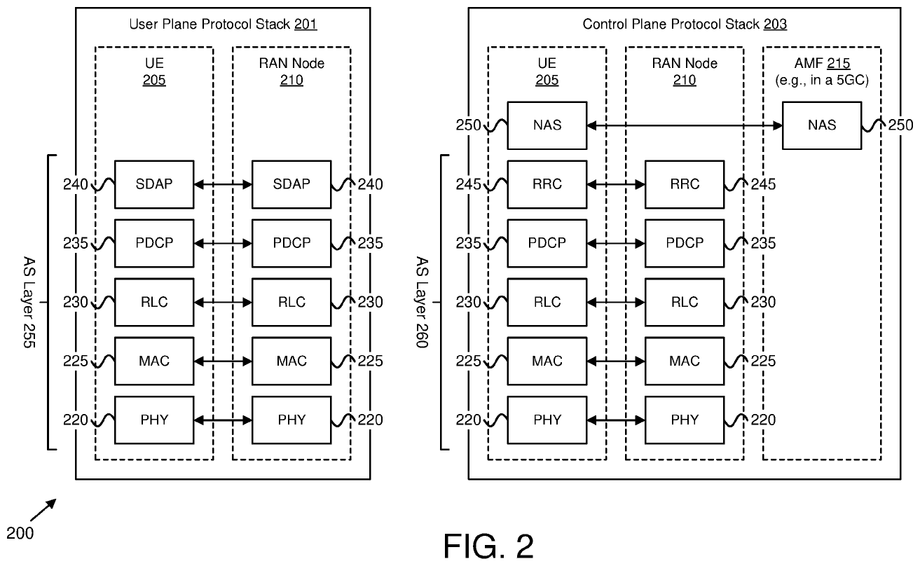

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The Access Stratum (“AS”) layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC. PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

Regarding 3GPP Release 16 (“Rel-16”) and Release 17 (“Rel-17”) positioning requirements, NR positioning based on NR Uu signals and System Aspects architecture (e.g., beam-based transmissions) was first specified in Rel-16. The target use cases also included commercial and regulatory (emergency services) scenarios as in 3GPP Release 15 (“Rel-15”). One example of performance requirements is found in Table 1, below:

TABLE 1
Positioning Performance Requirements

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Current 3GPP Rel-17 Positioning has recently defined the positioning performance requirements for Commercial and Industrial Internet of Things (“IoT”) use cases as follows in Table 2.

TABLE 2
Positioning Performance Requirements for IIoT

| Positioning Error | Commercial | IIoT |
|---|---|---|
| Horizontal Positioning | (<1 m) for | (<0.2 m) for |
| | 90% of UEs | 90% of UEs; |
| Vertical Positioning | (<3 m) for | (<1 m) for |
| | 90% of UEs | 90% of UEs |
| Physical layer latency for | (<10 ms) | (<10 ms) |
| position estimation of UE | | |
| End-to-End Latency for | (<100 ms) | (<100 ms, in the order |
| position estimation of UE | | of 10 ms is desired) |

The supported positioning techniques in Rel-16 are listed in Table 3, below. These techniques are defined in 3GPP Technical Specification (“TS”) 38.305.

TABLE 3
Supported Rel-16 UE positioning methods

| | | UE-assisted, | NG-RAN node | |
|---|---|---|---|---|
| Method | UE-based | LMF-based | assisted | SUPL |
| A-GNSS | Yes | Yes | No | Yes (UE-based and UE-assisted) |
| OTDOA ^{Note1, Note 2} | No | Yes | No | Yes (UE-assisted) |
| E-CID ^{Note 3} | No | Yes | Yes | Yes, for E-UTRA (UE-assisted) |
| Sensor | Yes | Yes | No | No |
| WLAN | Yes | Yes | No | Yes |
| Bluetooth | No | Yes | No | No |
| TBS ^{Note 4} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note1}
This includes Terrestrial Beacon System (“TBS”) positioning based on PRS signals.
^{Note 2}
In this version of the specification only Observed Time Difference of Arrival (“OTDOA”) based on LTE signals is supported.
^{Note 3}
This includes Cell-ID for NR method.
^{Note 4}
In this version of the specification only for TBS positioning based on MBS (Metropolitan Beacon System) signals.

Separate positioning techniques as indicated in Table 3 can be currently configured and performed based on the requirements of the LMF and UE capabilities. The transmission of Positioning Reference Signals (“PRS”) enables the UE to perform UE positioning-related measurements to enable the computation of a UE's location estimate and are configured per Transmission Reception Point (“TRP”), where a TRP may transmit one or more beams.

The following RAT-dependent positioning techniques are supported in Rel-16:

DL-TDOA: The DL-TDOA positioning method makes use of the DL Reference Signal Time Difference (“RSTD”) (and optionally DL PRS Reference Signal Received Power (“RSRP”)) of downlink signals received from multiple Transmission Points (“TPs”), at the UE. The UE measures the DL RSTD (and optionally DL PRS RSRP) of the received signals using assistance data received from the positioning server, and the resulting measurements are used along with other configuration information to locate the UE in relation to the neighboring TPs.

Downlink Angle-of-Departure (“DL-AoD”): The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multiple Round-Trip Time (“Multi-RTT”): The Multi-RTT positioning method makes use of the UE Receive-Transmit (“Rx-Tx”) measurements and DL PRS RSRP of downlink signals received from multiple TRPs, measured by the UE and the measured gNB Rx-Tx measurements and UL Sounding Reference Signal (“SRS”)-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round-Trip Time (“RTT”) at the positioning server which are used to estimate the location of the UE.

Enhanced Cell ID (“E-CID”)/NR E-CID: The E-CID positioning method estimates the position of a UE with the knowledge of its serving ng-eNB, gNB and cell and is based on LTE signals. The information about the serving ng-eNB, gNB and cell may be obtained by paging, registration, or other methods. NR E-CID positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

Uplink Time Different of Arrival (“UL-TDOA”): The UL-TDOA positioning method makes use of the UL-TDOA (and optionally UL SRS-RSRP) at multiple Received Power values (“RPs”) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE.

Uplink Angle-of-Arrival (“UL-AoA”): The UL-AoA positioning method makes use of the measured azimuth AoA (“A-AoA”) and the zenith AoA (“Z-AoA”) at multiple RPs of uplink signals transmitted from UE. The RPs measure A-AoA and Z-AoA of the received signals using assistance data received from the positioning server, and the resulting measurements are used along with other configuration information to estimate the location of the UE.

Regarding RAT-Independent Positioning Techniques, network-assisted GNSS methods make use of UEs that are equipped with radio receivers capable of receiving GNSS signals. In 3GPP specifications the term “GNSS” encompasses both global and regional/augmentation navigation satellite systems.

Examples of global navigation satellite systems include GPS, Modernized GPS, Galileo, GLONASS, and BeiDou Navigation Satellite System (“BDS”). Regional navigation satellite systems include Quasi-Zenith Satellite System (“QZSS”) while the many augmentation systems, are classified under the generic term of Space Based Augmentation Systems (“SBAS”) and provide regional augmentation services. In this concept, different GNSSs (e.g., GPS, Galileo, etc.) can be used separately or in combination to determine the location of a UE.

Regarding barometric pressure sensor positioning, the barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method should be combined with other positioning methods to determine the three-dimensional (“3D”) position of the UE.

Regarding WLAN positioning, the WLAN positioning method makes use of the WLAN measurements (AP identifiers and optionally other measurements) and databases to determine the location of the UE. The UE measures received signals from WLAN access points (“APs”), optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

Regarding Bluetooth positioning, the Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

A Terrestrial Beacon System (“TBS”) consists of a network of ground-based transmitters, broadcasting signals only for positioning purposes. Regarding TBS positioning, the current type of TBS positioning signals are the Metropolitan Beacon System (“MBS”) signals and PRS. The UE measures received TBS signals, optionally aided by assistance data, to calculate its location or to send measurements to the positioning server for position calculation.

Regarding motion sensor positioning, the motion sensor method makes use of different sensors such as accelerometers, gyros, magnetometers, to calculate the displacement of UE. The UE estimates a relative displacement based upon a reference position and/or reference time. The UE sends a report comprising the determined relative displacement which can be used to determine the absolute position. This method should be used with other positioning methods for hybrid positioning.

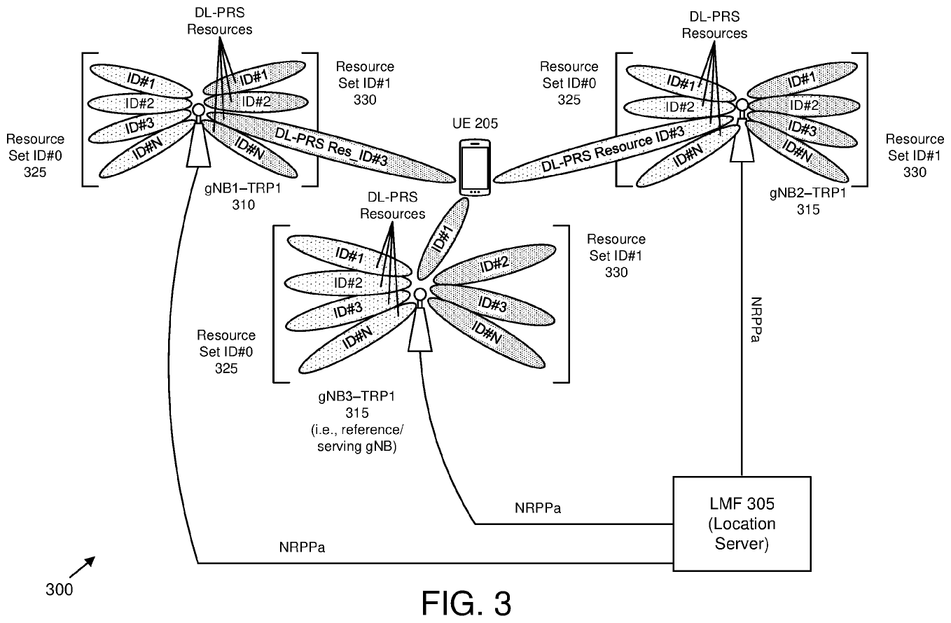

FIG. 3 depicts a network architecture 300 for NR beam-based positioning measurements and reference signals (“RS”), according to embodiments of the disclosure. Here, the downlink positioning reference signal (“DL-PRS”) can be transmitted by different base stations (serving gNB and neighboring gNB) using narrow beams over Frequency Range #1 Between (“FR1”, i.e., frequencies from 410 MHz to 7125 MHz) and Frequency Range #2 (“FR2”, i.e., frequencies from 24.25 GHz to 52.6 GHZ), which is relatively different when compared to LTE where the PRS was transmitted across the whole cell. As illustrated in FIG. 3, a UE 205 may receive DL-PRS from a neighboring first gNB/TRP (denoted “gNB1-TRP1”) 310, from a neighboring second gNB (denoted “gNB2-TRP1”) 315, and also from a third gNB/TRP (denoted “gNB3-TRP1”) 320 which is a reference or serving gNB.

Here, the DL-PRS can be locally associated with a DL-PRS Resource ID and Resource Set ID for a base station (i.e., TRP). In the depicted embodiments, each gNB 310, 315, 320 is configured with a first Resource Set ID (depicted as “Resource Set ID #0”) 325 and a second Resource Set ID (depicted as “Resource Set ID #1”) 330. As depicted, the UE 205 receives DL-PRS on transmission beams; here, receiving DL-PRS from the gNB1-TRP1 310 on DL-PRS Resource ID #3 from the second Resource Set ID (“Resource Set ID #1”) 630, receiving DL-PRS from the gNB2-TRP1 315 on DL-PRS Resource ID #3 from the first Resource Set ID (“Resource Set ID #0”) 625, and receiving DL-PRS from the gNB3-TRP1 320 on DL-PRS Resource ID #1 from the second Resource Set ID (“Resource Set ID #1”) 330.

Similarly, UE positioning measurements such as Reference Signal Time Difference (“RSTD”) and PRS RSRP measurements are made between different beams (e.g., between a different pair of DL PRS resources or DL PRS resource sets)—as opposed to different cells as was the case in LTE. The LMF server 305 uses the UE positioning measurements to determine the UE's location (e.g., absolute location). In addition, there are additional UL positioning methods for the network to exploit in order to compute the target UE's location. Table 4 and Table 5 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, Inertial Measurement Unit (“IMU”) sensor, WLAN and Bluetooth technologies for performing target device (i.e., UE) positioning.

TABLE 4
UE Measurements to enable RAT-dependent positioning techniques

| | | To facilitate support of the |
|---|---|---|
| | | following positioning |
| DL/UL Reference Signals | UE Measurements | techniques |
| Rel.16 DL PRS | DL RSTD | DL-TDOA |
| Rel.16 DL PRS | DL PRS RSRP | DL-TDOA, DL-AoD, Multi-RTT |
| Rel.16 DL PRS/Rel.16 SRS for | UE Rx − Tx time difference | Multi-RTT |
| positioning | | |
| Rel. 15 Synchronization Signal | SS-RSRP (RSRP for RRM), SS- | E-CID |
| Block (“SSB”)/Channel State | RSRQ (for RRM), CSI-RSRP | |
| Information (“CSI”)-RS for Radio | (for RRM), CSI-RSRQ (for | |
| Resource Management (“RRM”) | RRM), SS-RSRPB (for RRM) | |

TABLE 5
gNB Measurements to enable RAT-dependent positioning techniques

| | | To facilitate support of the |
|---|---|---|
| | | following positioning |
| DL/UL Reference Signals | gNB Measurements | techniques |
| Rel. 16 SRS for positioning | UL Relative Time of Arrival | UL-TDOA |
| | (“UL-RTOA”) | |
| Rel. 16 SRS for positioning | UL SRS-RSRP | UL-TDOA, UL-AoA, Multi-RTT |
| Rel. 16 SRS for positioning, | gNB Rx − Tx time difference | Multi-RTT |
| Rel. 16 DL PRS | | |
| Rel. 16 SRS for positioning, | AoA and ZoA | UL-AoA, Multi-RTT |

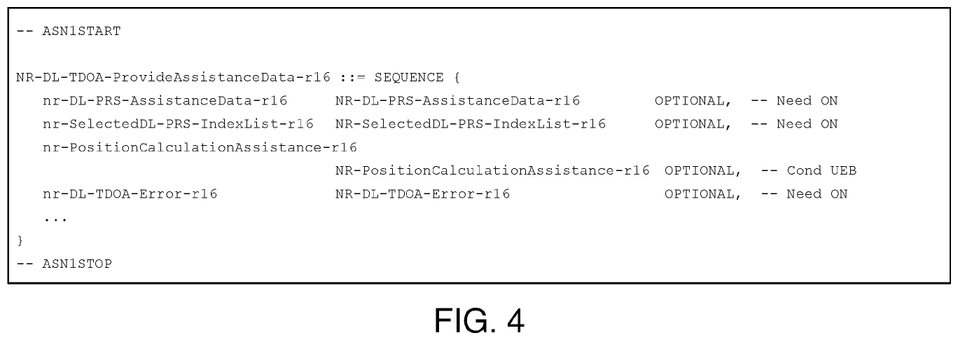

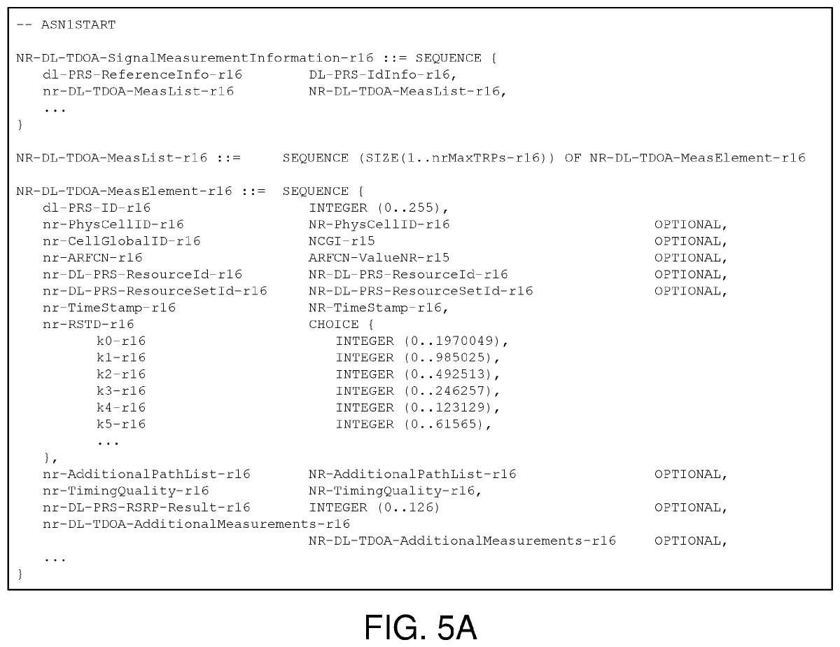

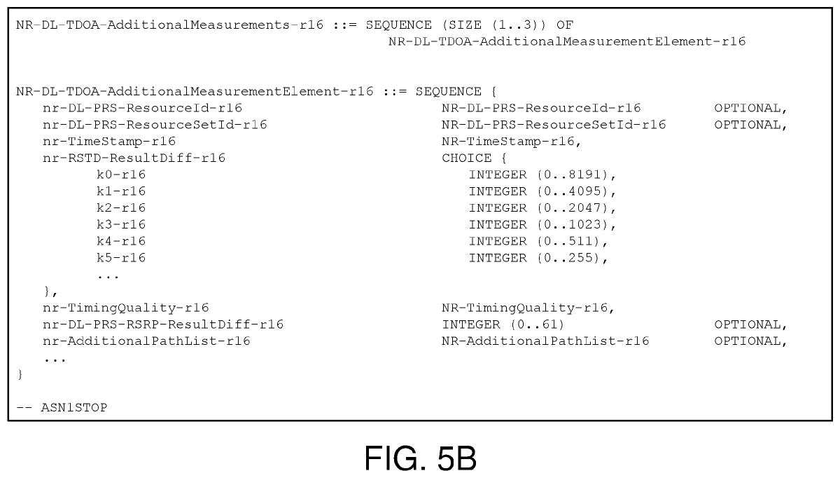

Regarding measurement and report configuration and signaling, UE measurement configurations and reporting have been defined in 3GPP TS 38.215, which are applicable to DL-based positioning techniques. For a conceptual overview of the current implementation in Rel-16, the assistance data configurations (see FIG. 4) and measurement information (see FIG. 5A-5B) are provided for each of the supported positioning techniques.

FIG. 4 depicts one example of an Abstract Syntax Notation 1 (“ASN.1”) implementation of DL-TDOA Assistance Data, according to embodiments of the disclosure. The Information Element (“IE”) NR-DL-TDOA-ProvideAssistanceData is used by the location server to provide assistance data to enable UE-assisted and UE-based NR downlink TDOA. It may also be used to provide NR DL-TDOA positioning specific error reason.

FIGS. 5A-5B depicts one example of an ASN. 1 implementation of a DL-TDOA Measurement Report, according to embodiments of the disclosure, where the DL-TDOA Measurement Report begins at FIG. 5A and continues on FIG. 5B.

At FIG. 5A, the IE NR-DL-TDOA-SignalMeasurementInformation is used by the target device to provide NR DL-TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target device selects a reference resource per TRP, and compiles the measurements per TRP based on the selected reference resource.

Regarding RAT-dependent Positioning Measurements, the different DL measurements including DL PRS-RSRP, DL RSTD and UE Rx-Tx Time Difference required for the supported RAT-dependent positioning techniques are shown in Table 6. The following measurement configurations are specified as follows:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 6
DL Measurements required for DL-based positioning methods
DL PRS reference signal received power (DL PRS-RSRP)

| | |
|---|---|
| Definition | DL PRS reference signal received power (DL PRS-RSRP), is defined as the linear |
| | average over the power contributions (in [W]) of the resource elements that carry DL |
| | PRS reference signals configured for RSRP measurements within the considered |
| | measurement frequency bandwidth. |
| | For FR1, the reference point for the DL PRS-RSRP shall be the antenna connector of |
| | the UE. For FR2, DL PRS-RSRP shall be measured based on the combined signal |
| | from antenna elements corresponding to a given receiver branch. For FR1 and FR2, if |
| | receiver diversity is in use by the UE, the reported DL PRS-RSRP value shall not be |
| | lower than the corresponding DL PRS-RSRP of any of the individual receiver |
| | branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing difference |
| | between the positioning node j and the reference positioning node i, defined as |
| | T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one subframe |
| | from positioning node i that is closest in time to the subframe received from |
| | positioning node j. |
| | Multiple DL PRS resources can be used to determine the start of one subframe from a |
| | positioning node. |
| | For FR1, the reference point for the DL RSTD shall be the antenna connector of the |
| | UE. For FR2, the reference point for the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning node, |
| | defined by the first detected path in time. |
| | T_{UE-TX} is the UE transmit timing of uplink subframe #j that is closest in time to the |
| | subframe #i received from the positioning node. |
| | Multiple DL PRS resources can be used to determine the start of one subframe of the |
| | first arrival path of the positioning node. |
| | For FR1, the reference point for T_{UE-RX} measurement shall be the Rx antenna connector |
| | of the UE and the reference point for T_{UE-TX} measurement shall be the Tx antenna |
| | connector of the UE. For FR2, the reference point for T_{UE-RX} measurement shall be the |
| | Rx antenna of the UE and the reference point for T_{UE-TX} measurement shall be the Tx |
| | antenna of the UE. |
| Applicable for | RRC_CONNECTED intra-frequency |
| | RRC_CONNECTED inter-frequency |

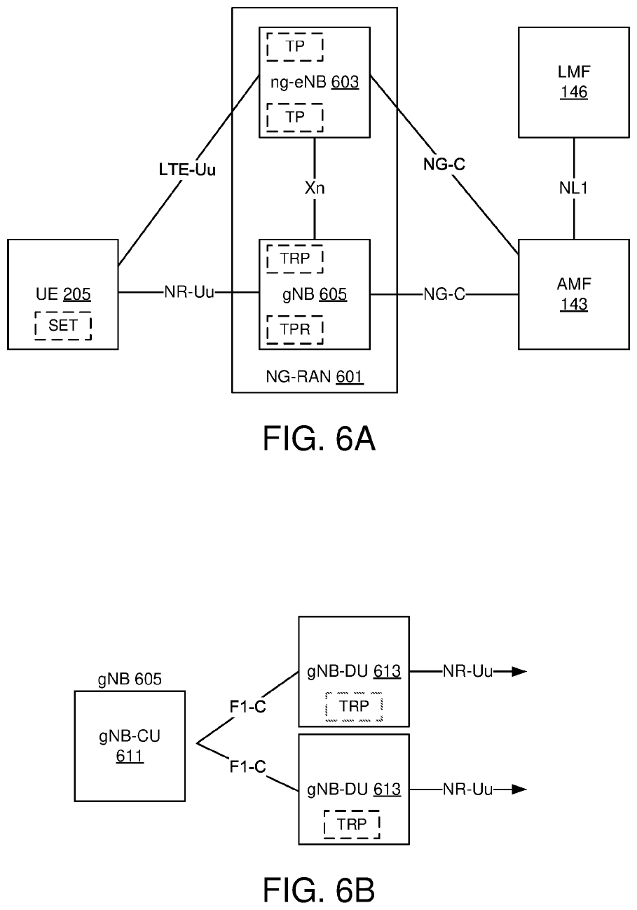

FIGS. 6A-6B depict UE Positioning Overall Architecture applicable to NG-RAN, according to embodiments of the disclosure.

FIG. 6A shows the architecture in 5GS applicable to positioning of a target UE 205 with NR or E-UTRA access. The AMF 143 receives a request for some location service associated with a particular target UE 205 from another entity (e.g., Gateway Mobile Location Center (“GMLC”) or UE) or the AMF 143 itself decides to initiate some location service on behalf of a particular target UE 205 (e.g., for an IP Multimedia System (“IMS”) emergency call from the UE). The AMF 143 then sends a location service request to an LMF 146.

The LMF 146 processes the location services request, which may include transferring assistance data to the target UE 205 to assist with UE-based and/or UE-assisted positioning and/or may include positioning of the target UE 205. The LMF 146 then returns the result of the location service back to the AMF 143 (e.g., a position estimate for the UE 205). In the case of a location service requested by an entity other than the AMF 143 (e.g., a GMLC or UE), the AMF 143 returns the location service result to this entity.

An NG-RAN node 601 may control several TRPs/TPs, such as remote radio heads, or DL-PRS-only TPs for support of PRS-based TBS. The NG-RAN node 601 may be an ng-eNB 603 (comprising one or multiple TPs) and/or a gNB 605 (comprising one or multiple TRPs).

An LMF 146 may have a proprietary signaling connection to an E-SMLC which may enable an LMF 146 to access information from E-UTRAN (e.g., to support the OTDOA for E-UTRA positioning method using downlink measurements obtained by a target UE 205 of signals from eNBs and/or PRS-only TPs in E-UTRAN). Details of the signaling interaction between an LMF 146 and E-SMLC (Enhanced Serving Mobile Location Centre) are outside the scope of this specification.

An LMF 146 may have a proprietary signaling connection to an SUPL Location Platform (“SLP”). The SLP is the Secure User Plane Location (“SUPL”) entity responsible for positioning over the user plane. Further details of user-plane positioning are provided in 3GPP TS 38.305 Annex A. Details of the signaling interaction between an LMF 146 and SLP are outside the scope of this specification.

FIG. 6B depicts an example of split gNB architecture, comprising a gNB control unit (“gNB-CU”) 611 (e.g., at the gNB 605) and a plurality of gNB distributed units (“gNB-DUs”) 613. Each gNB-DU 613 may include TRP functionality where the TRP functionality may support functions for a Transmission Point (“TP”), a Reception Point (“RP”) or both TP and RP. A gNB-DU 613 which includes TRP functionality does not need to offer cell services.

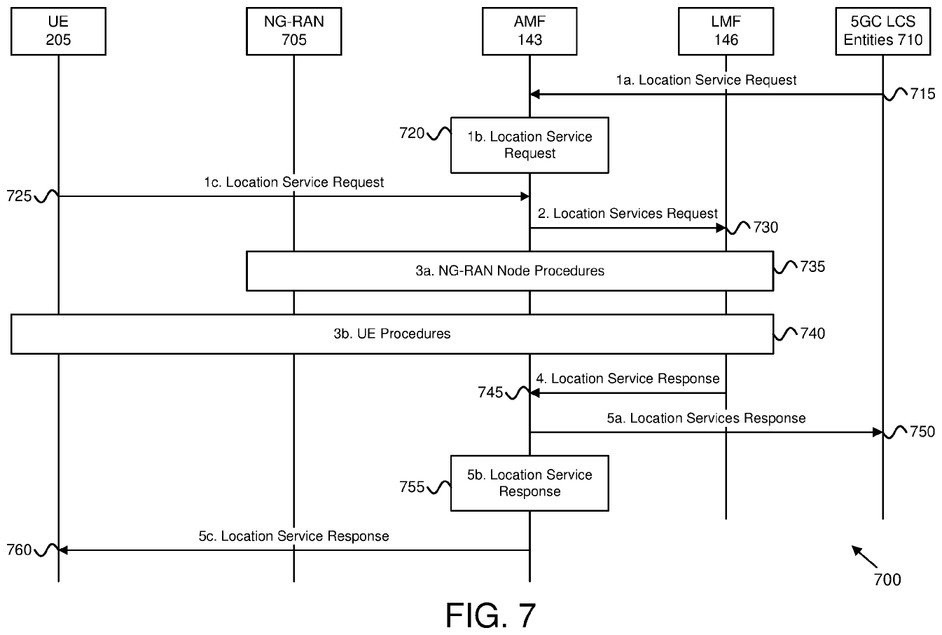

FIG. 7 depicts a procedure 700 for LCS support by NG-RAN. Regarding RAN-UE positioning operations, to support positioning of a target UE and delivery of location assistance data to a UE with NG-RAN access in 5GS, location related functions are distributed as shown in the architecture in FIG. 6, and as clarified in greater detail in 3GPP TS 23.501 and 3GPP TS 23.273. The overall sequence of events applicable to the UE 205, NG-RAN node 705, and LMF 146 for any location service is shown in FIG. 7.

Note that when the AMF 143 receives a Location Service Request in case of the UE 205 is in an idle connection management (“CM-IDLE”) state (i.e., where the UE 205 does not have a signaling connection with the serving AMF 143), the AMF 143 performs a network triggered service request (e.g., as defined in 3GPP TS 23.502 and 3GPP TS 23.273) in order to establish a signaling connection with the UE 205 and assign a specific serving gNB or ng-eNB (i.e., the NG-RAN node 705). The UE 205 is assumed to be in connected mode before the beginning of the flow shown in the FIG. 7. That is, any signaling that might be required to bring the UE 205 to connected mode prior to step 1a is not shown. The signaling connection may, however, be later released (e.g., by the NG-RAN node 705 as a result of signaling and data inactivity) while positioning is still ongoing.

At Step 1, either Step 1a, Step 1b, or Step 1c is performed. At Step 1a, some entity in the 5GC (e.g., GMLC) requests some location service (e.g., positioning) for a target UE 205 to the serving AMF 143 (see messaging 715). At Step 1b, the serving AMF 143 for a target UE 205 determines the need for some location service, e.g., to locate the UE 205 for an emergency call (see block 720). At Step 1c, the UE 205 requests some location service (e.g., positioning or delivery of assistance data) to the serving AMF 143 at the NAS level (see messaging 725).

At Step 2, the AMF 143 transfers the location service request to an LMF 146 (see messaging 730).

At Step 3a, the LMF 146 instigates location procedures with the serving and possibly neighboring ng-eNB or gNB in the NG-RAN—e.g., to obtain positioning measurements or assistance data (see block 735).

At Step 3b, in addition to Step 3a—or instead of Step 3a, the LMF 146 instigates location procedures with the UE 205—e.g., to obtain a location estimate or positioning measurements or to transfer location assistance data to the UE 205.

At Step 4, the LMF 146 provides a location service response to the AMF 143 and includes any needed results—e.g., success or failure indication and, if requested and obtained, a location estimate for the UE 205.

At Step 5a, if Step 1a was performed, the AMF 143 returns a location service response to the 5GC LCS entities 710 in step 1a and includes any needed results—e.g., a location estimate for the UE 205.

At Step 5b, if Step 1b occurred, the AMF 143 uses the location service response received in Step 4 to assist the service that triggered this in Step 1b (e.g., may provide a location estimate associated with an emergency call to a Gateway Mobile Location Centre (“GMLC”)).

At Step 5c, if Step 1c was performed, the AMF 143 returns a location service response to the UE 205 and includes any needed results—e.g., a location estimate for the UE 205.

Location procedures applicable to NG-RAN occur in Steps 3a and 3b in FIG. 7. These procedures are defined in greater detail in this specification. Other steps in FIG. 7 are applicable only to the 5GC LCS entities 710 and are described in greater detail in 3GPP TS 23.502 and 3GPP TS 23.273.

Steps 3a and 3b can involve the use of different position methods to obtain location related measurements for a target UE 205 and from these computes a location estimate, and possibly additional information like velocity. The case that the NG-RAN node 705 functions as an LCS client is not supported in this version of the specification.

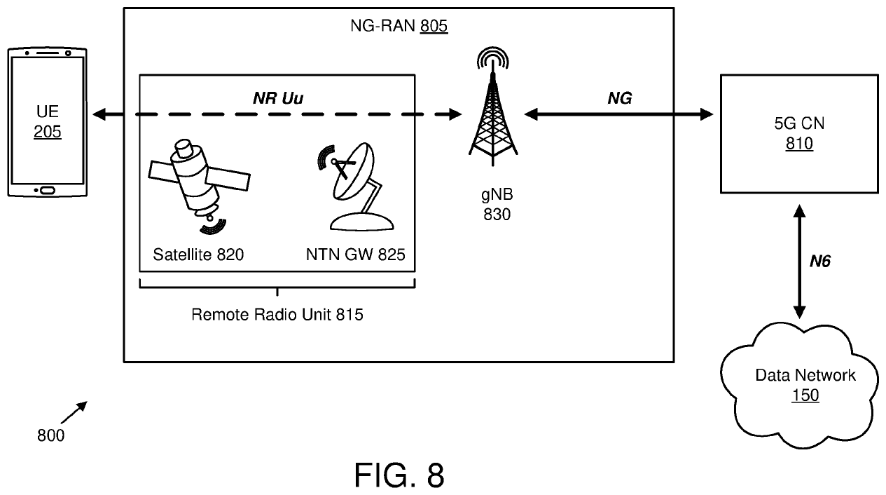

FIG. 8 depicts a transparent-payload satellite-based NG-RAN architecture 800, according to embodiments of the disclosure. The satellite payload implements frequency conversion and a Radio Frequency (“RF”) amplifier in both up link and down link direction. It corresponds to an analogue RF repeater. Hence the satellite 820 repeats the NR-Uu radio interface from the feeder link (between the NTN GW 825 and the satellite 820) to the service link (between the satellite 820 and the UE 205) and vice versa. As depicted in FIG. 8, the satellite 820 and NTN GW 825 form a remote radio unit 815, the remote radio unit 815 and gNB 830 form the NG-RAN 805, which provides access to the 5G CN 810. The UE 205 accesses the data network 150 via the NG-RAN 805 and 5G CN 810.

The Satellite Radio Interface (“SRI”) on the feeder link is the NR-Uu. In other words, the satellite 820 does not terminate NR-Uu. The NTN Gateway (“GW”) 825 supports all necessary functions to forward the signal of NR-Uu interface. Different transparent satellites may be connected to the same gNB 830 on the ground. Note that while several gNBs may access a single satellite payload, the description has been simplified to a unique gNB 830 accessing the satellite payload, without loss of generality.

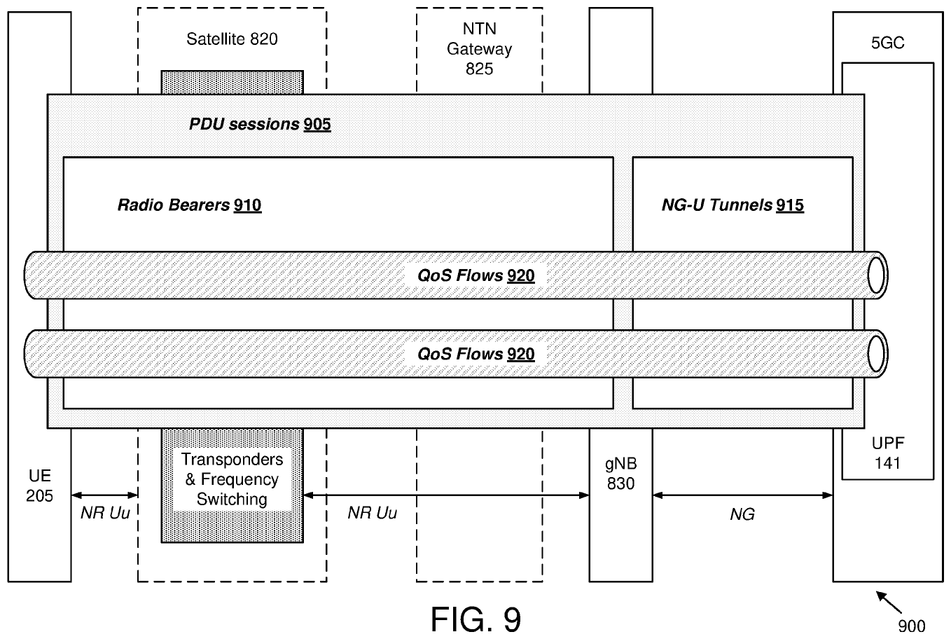

FIG. 9 depicts the architecture 900 of a transparent-payload satellite-based NG-RAN and the mapping to QoS flows. The UE 205 has access to the 5G system via a 3GPP NR based radio interface. As depicted, the UE 205 establishes one or more PDU sessions 905 with the 5GC via the satellite 820, the NTN GW 825, and the gNB 830. The PDU session(s) 905 comprise one or more Radio Bearers 910 between the UE 205 and the gNB 830 (via the satellite 820 and the NTN GW 825) and comprises one or more NG-U tunnels 915 between the gNB 830 and the UPF 141 in the 5GC. In the embodiment of FIG. 9, the PDU session(s) 905 support two QoS flows 920; however, in other embodiments the PDU session(s) 905 may support more or fewer QoS flows.

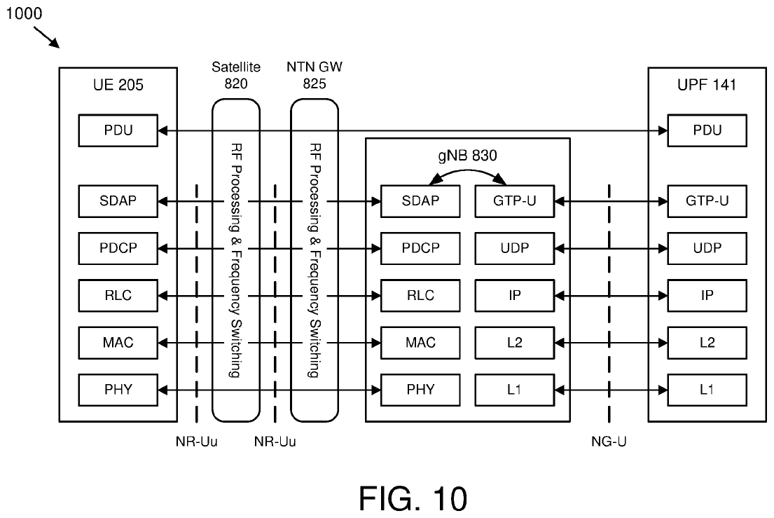

FIG. 10 depicts a user plane protocol stack 1000 for the transparent-satellite based NG-RAN. The user data is transported between the UE 205 and the 5GC, as usual, but via the NTN GW 825. Here, the satellite 820 and NTN GW 825 perform RF processing and frequency switching.

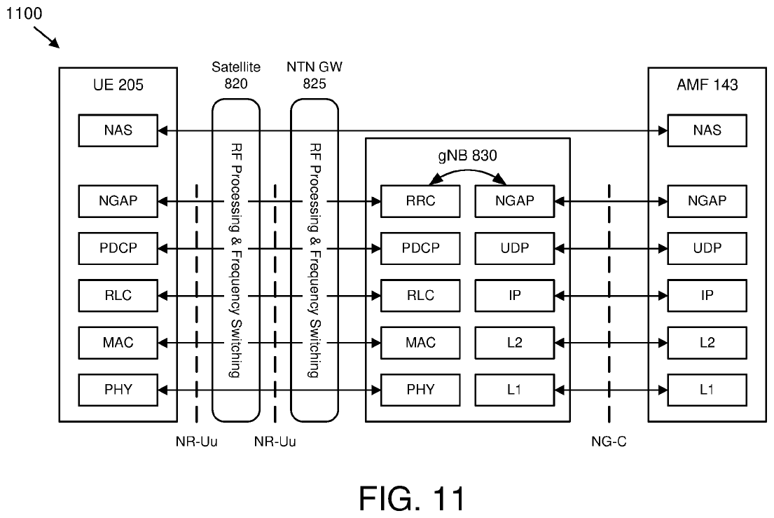

FIG. 11 depicts a control plane protocol stack 1100 for the transparent-satellite based NG-RAN. The NAS layer (comprising NAS Session Management (“NAS-SM”) and (NAS mobility management (“NAS-MM”) sublayers) signaling from the UE 205 and the Next Generation Application Protocol (“NG-AP”) signaling from the gNB 830 are transported toward the 5GC (comprising AMF 143) and vice versa. Again, the satellite 820 and NTN GW 825 perform RF processing and frequency switching.

Regarding regenerative-payload satellite architectures, the satellite payload implements regeneration of the signals received from Earth. The depicted NG-RAN logical architecture is used as baseline for NTN scenarios. The satellite payload may also provide ISL between satellites.

In one embodiment, NR-Uu radio interface on the service link between the UE and the satellite. In another embodiment, Satellite Radio Interface (“SRI”) on the feeder link between the NTN GW and the satellite. Note that SRI is a transport link between NTN GW and satellite. The NTN GW is a Transport Network Layer node and supports all necessary transport protocols.

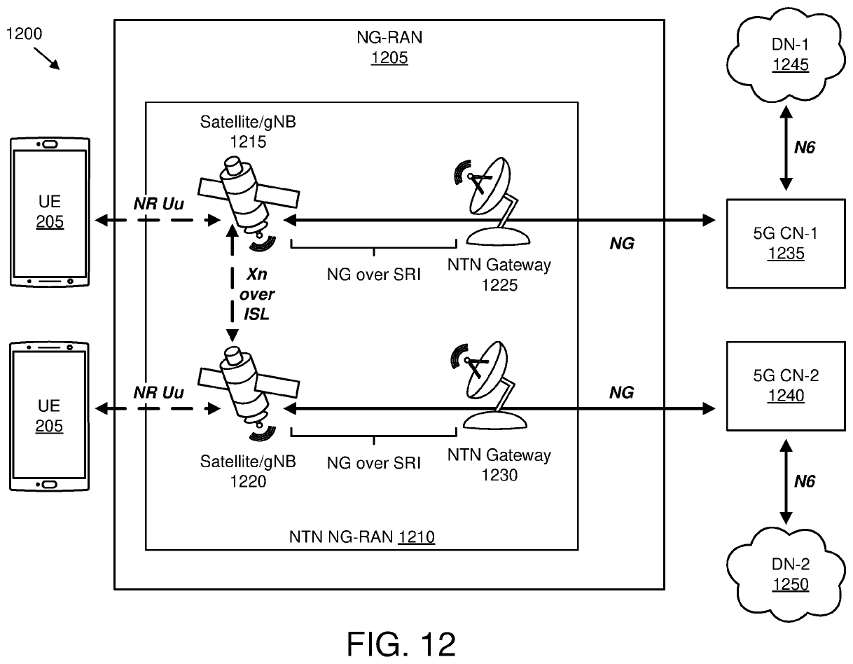

FIG. 12 illustrates a regenerative-payload satellite-based NG-RAN architecture 1200 whereby a UE served by a gNB on board a satellite (denoted as “satellite/gNB”) may access the 5G CN via ISL. ISL is a transport link between satellites. ISL may be a radio interface or an optical interface that may be 3GPP or non 3GPP defined but this is out of the study item scope. FIG. 12 depicts multiple UEs 205, each in communication with a satellite/gNB through a (NTN) NR Uu interface. In the depicted embodiment, there are two satellites/gNBs (1215 and 1220), which may be in communication with each other through a Xn interface via ISL. Additionally, a first satellite/gNB 1215 is in communication with a first 5G CN (denoted “5G CN-1”) 1235 via the NTN gateway 1225 through a NG interface over SRI, while a second satellite/gNB 1220 is in communication with a second 5G CN (denoted “5G CN-2”) 1240 via the NTN gateway 1230 through a NG interface over SRI.

The gNB on board different satellites may be connected to the same 5GC on the ground. If the satellite hosts more than one gNB, the same SRI will transport all the corresponding NG interface instances. The NG-RAN 1205 comprises the NTN NG-RAN 1210, which comprises the satellites/gNBs 1215, 1220 and NTN gateways 1225, 1230. The 5G CN-1 1235 provides access to a first data network (denoted “DN-1”) 1245, while the 5G CN-2 1240 provides access to a second data network (denoted “DN-2”) 1250.

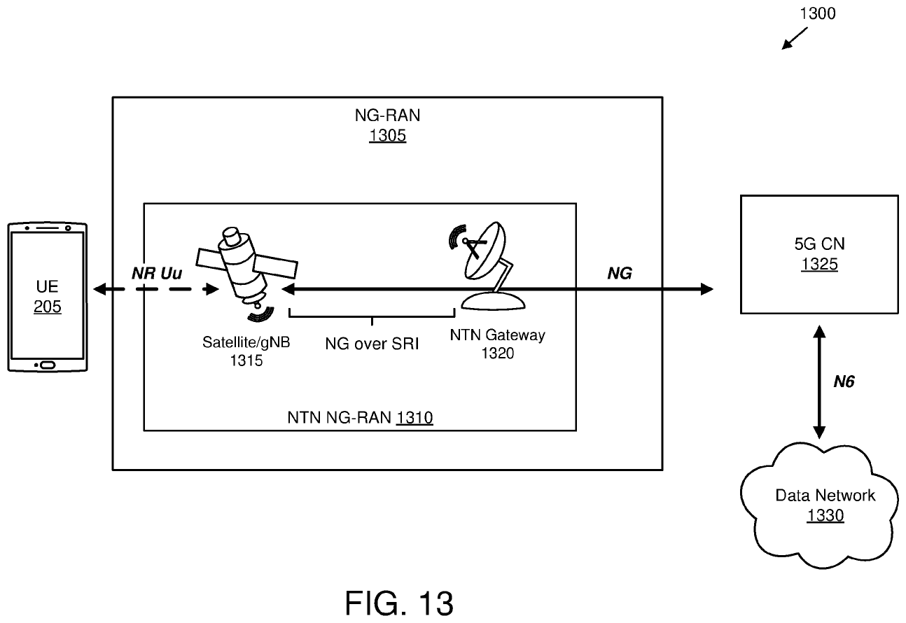

FIG. 13 depicts a regenerative-payload satellite-based NG-RAN architecture 1300 comprising a UE 205 served by a gNB on board a satellite (depicted as “satellite/gNB” 1315) without ISL, according to embodiments of the disclosure. Note that the satellite/gNB 1315 may embark additional traffic routing functions that are out of RAN scope. In FIG. 13 the UE 205 is in communication with a satellite/gNB 1315 through a (NTN) NR Uu interface. Additionally, the satellite/gNB 1315 is in communication with an NTN gateway 1320 through a NG interface over SRI, and the NTN gateway 1320 is in communication with a 5G CN 1325 through a NG interface. The NG-RAN 1305 comprises an NTN NG-RAN 1310, which comprises at least the satellite 1315 and NTN gateway 1320. The 5G CN 1325 provides access to a data network 1330.

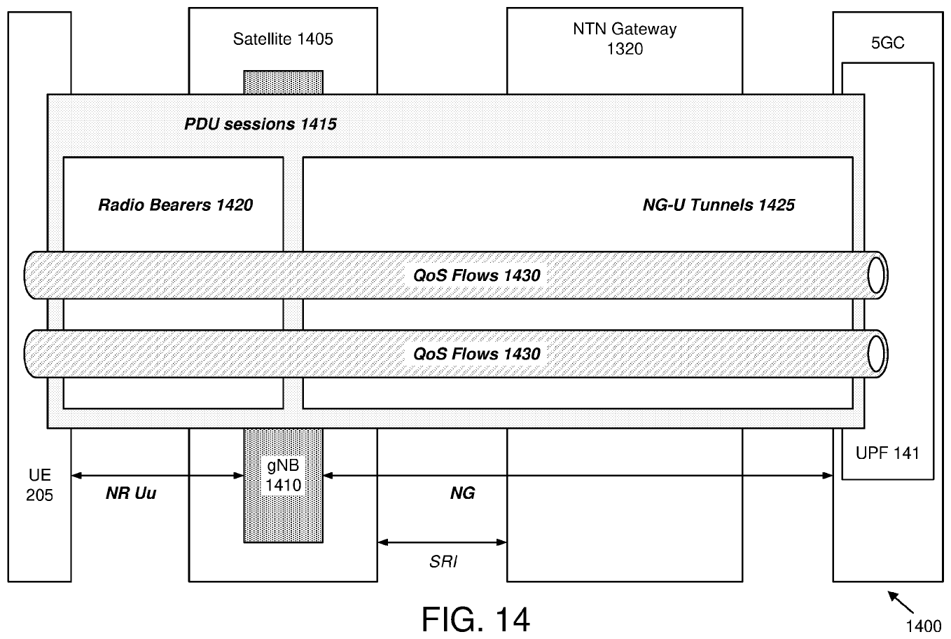

FIG. 14 depicts the architecture 1400 of a regenerative-payload satellite-based NG-RAN and the mapping to QoS flows. Here, the satellite 1405 has a gNB 1410 on board. As depicted, the UE 205 establishes one or more PDU sessions 1415 with the 5GC via the satellite 1405, the NTN gateway 1320, and the gNB 1410. The PDU session(s) 1415 comprise one or more Radio Bearers 1420 between the UE 205 and the gNB 1410 (via the satellite 1405) and comprises one or more NG-U tunnels 1425 between the gNB 1410 and NTN gateway 1320 (via satellite 1405) and the UPF 141 in the 5GC. In the embodiment of FIG. 14, the PDU session(s) 1415 support two QoS flows 1430; however, in other embodiments the PDU session(s) 1415 may support more or fewer QoS flows 1430.

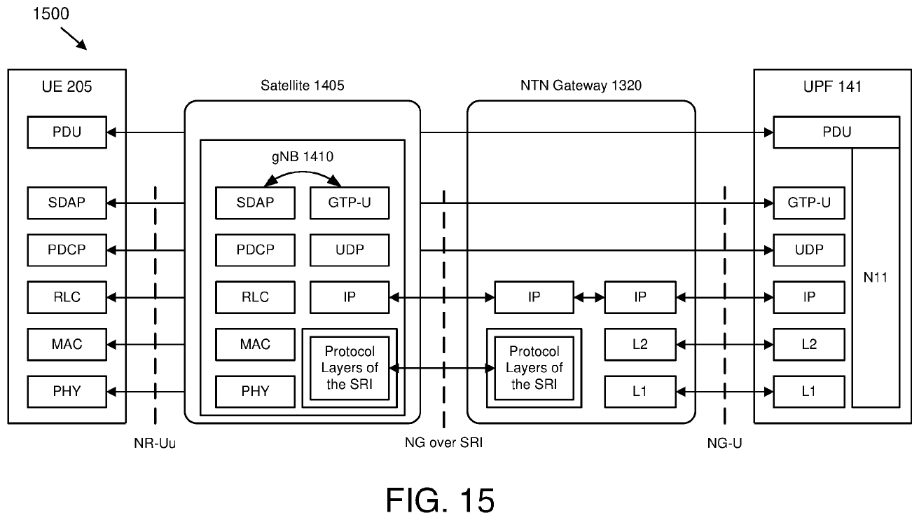

FIG. 15 depicts a user plane protocol stack 1500 for a PDU session according to NG-RAN protocol architecture for a regenerative satellite 1405 (i.e., with gNB 1410 on board). The user plane Protocol stack of the Satellite Radio Interface (SRI) is used to transport user plane traffic between the satellite 1405 and the NTN Gateway 1320. The User plane PDUs are transported over GTP-U tunnels, as usual, between the 5GC and the on-board gNB 1410, but via the NTN Gateway 1320.

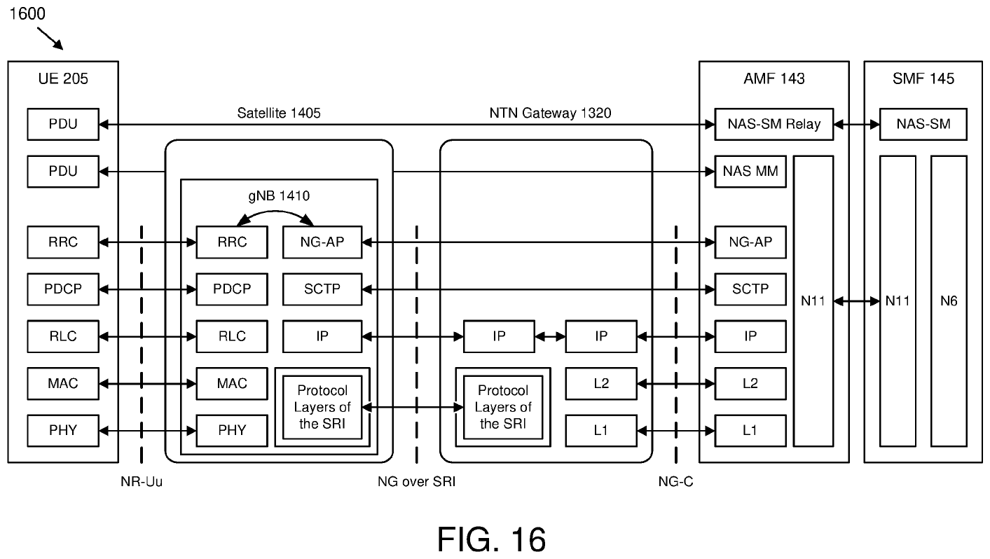

FIG. 16 depicts a control plane protocol stack 1600 for a PDU session according to NG-RAN protocol architecture for a regenerative satellite 1405 (i.e., with gNB 1410 on board). The NG-AP is transported over Stream Control Transmission Protocol (“SCTP”), between the 5GC and the on-board gNB 1410, as usual, but via the NTN Gateway 1320. The NAS protocol is also transported by the NG-AP protocol, between the 5GC (i.e., comprising the AMF 143 and SMF 145) and the on-board gNB 1410, via the NTN Gateway 1320.

The present disclosure provides solution enhancements for performing 3GPP positioning via the NR NTN NG-RAN architectural framework.

In various embodiments, the below solutions may be implemented in combination with each other to support NR positioning using the supported NTN interfaces and network entities/nodes. For the purposes of this disclosure, a positioning-related reference signal may refer to a reference signal used for positioning procedures/purposes in order to estimate a target UE's location, e.g., PRS, or based on existing reference signals such as SRS; a target UE can be referred to as the device/entity to be localized/positioned.

Disclosed herein are multiple solution options, which includes different scenarios to support LCS (3GPP and non-3GPP based location services) using transparent-payload and regenerative-payload satellite NG-RAN architectures. Throughout the present disclosure, a system/network based on a transparent payload architecture, in which a Non-Terrestrial Transmit-Receive Point (“NT-TRP”) such as a satellite may relay signals with limited or no baseband processing, may be referred to as a transparent system/network for the sake of brevity. Similarly, a system/network based on a regenerative payload architecture, in which an NT-TRP such as a satellite may comprise all or some base station functionalities, may be referred to as a regenerative system/network for the sake of brevity.

Disclosed herein are methods to support different types of location requests over satellite NG-RAN architectures. Disclosed herein are methods to describe the supported location service functionality for different NTN nodes/entities, e.g., gNB as a satellite, gateway as well as types of signaling interfaces required to configure and report the UE's location depending on the type of NTN NG-RAN architecture.

The present embodiments include solutions to integrate NTN and LCS NG-RAN architectures for the purposes of supporting accurate, reliable, and low-latency location services where applicable.

Embodiments of the first solution describe NG-RAN architectural options that can address the support for positioning using NTN entities and nodes.

Solution 1-1 relates to NTN positioning architecture based on the same serving LMF. According to solution 1-1, one or multiple gateways in an NTN are connected to the same serving LMF via the AMF, where each gateway may support one or multiple satellites. The gateway may perform complete gNB functionality, e.g., in the case of transparent payload, or perform partial or no gNB functionality, e.g., in case of regenerative payload.

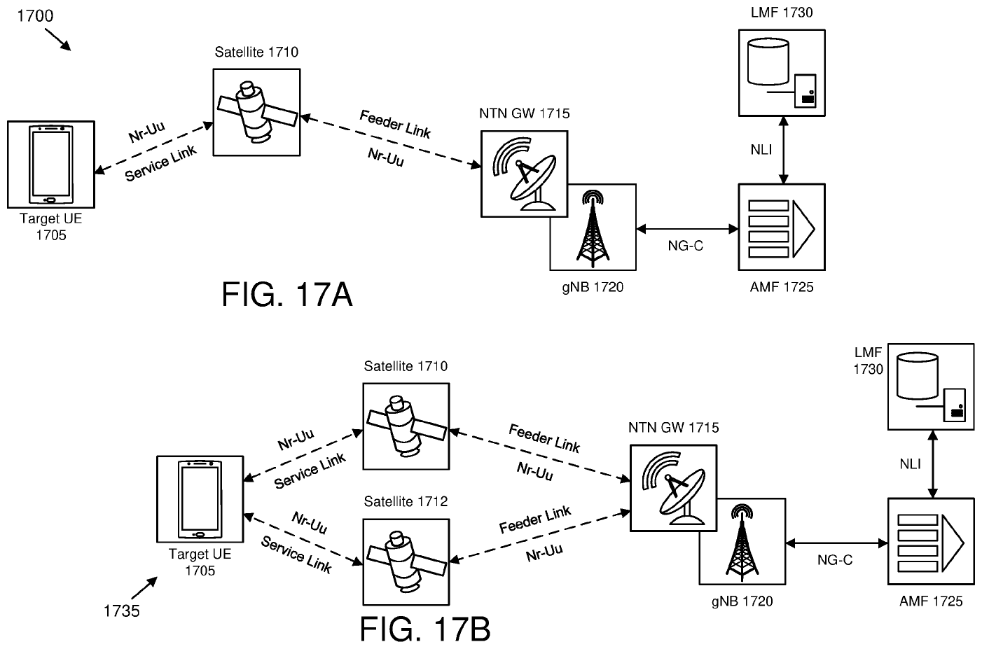

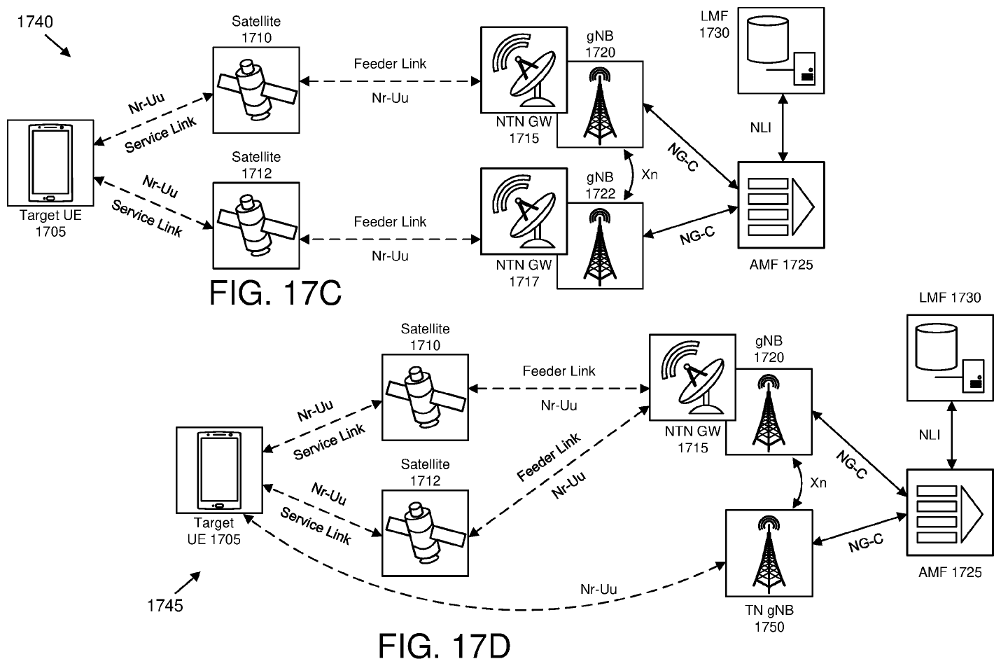

FIGS. 17A-17D depicts different architectures for positioning based on a same LMF 1730 using a transparent NTN system. FIG. 17A depicts a first positioning architecture 1700 where the target UE 1705 connects to one satellite, according to embodiments of the disclosure. FIG. 17B depicts a second positioning architecture 1735 where multiple satellites connect to a single gateway, according to embodiments of the disclosure. FIG. 17C depicts a third positioning architecture 1740 where multiple satellites connect to multiple gateways, according to embodiments of the disclosure. FIG. 17D depicts a fourth positioning architecture 1745 of multi-connectivity involving transparent NTN-based NG-RAN and cellular NG-RAN, according to embodiments of the disclosure.

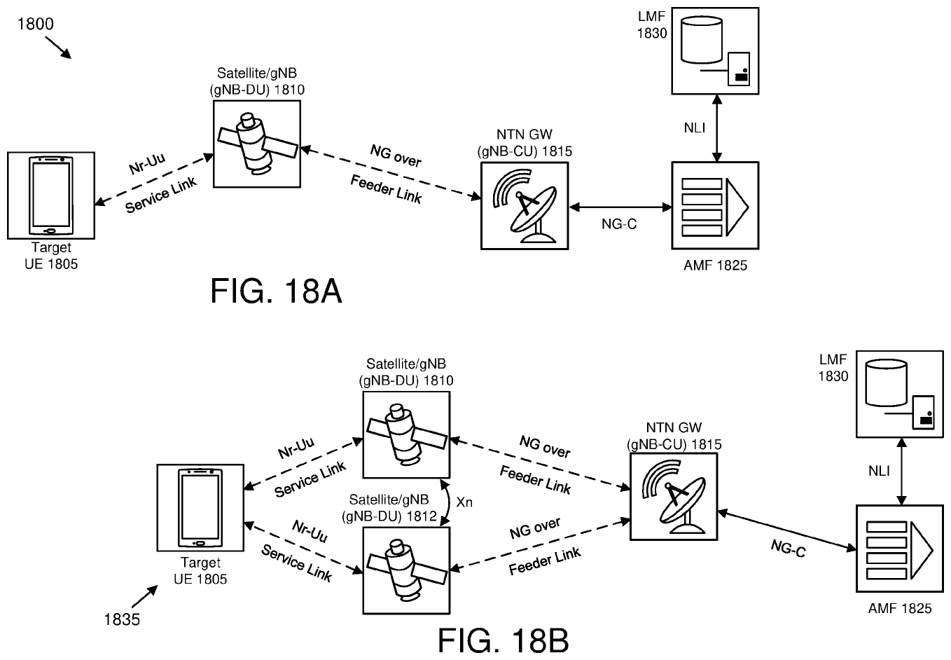

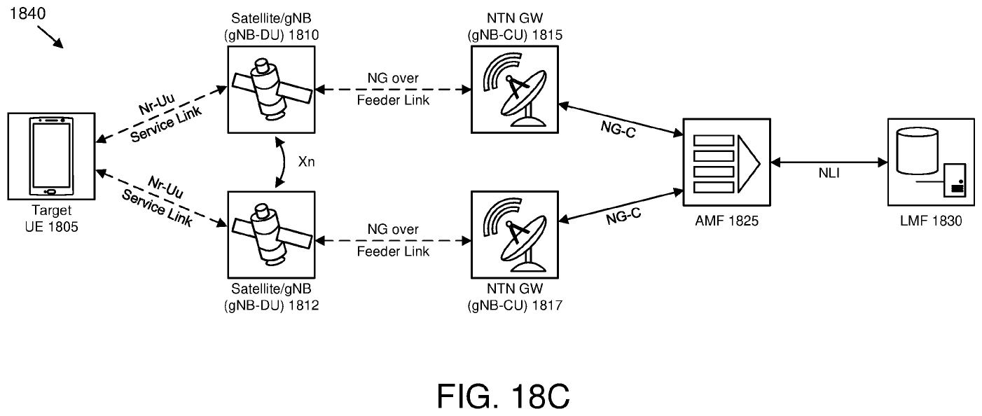

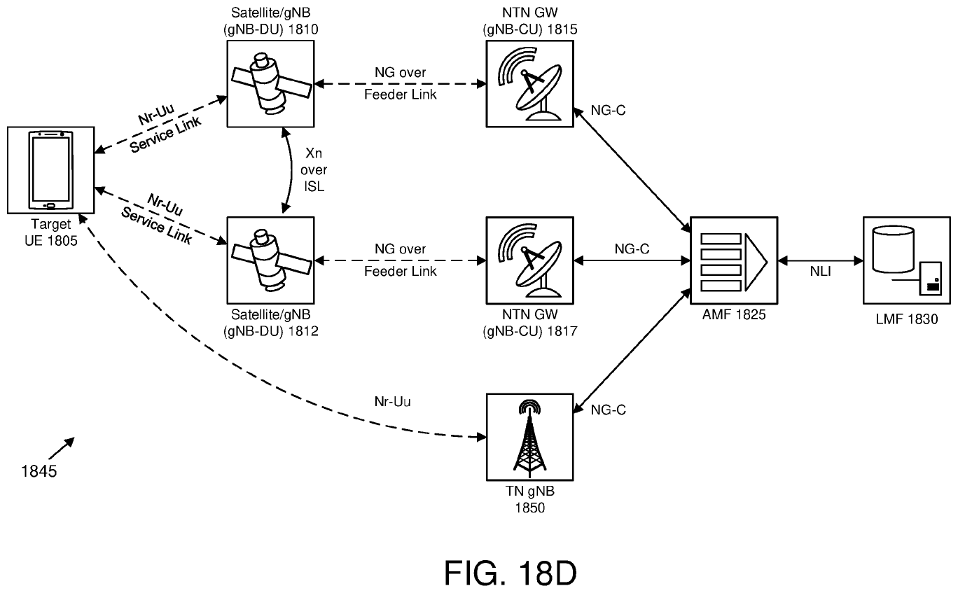

FIGS. 18A-18D depicts different architectures for positioning based on a same LMF 1830 using a regenerative NTN system. FIG. 18A depicts a first positioning architecture 1800 where the target UE 1805 connects to one satellite, according to embodiments of the disclosure. FIG. 18B depicts a second positioning architecture 1835 where multiple satellites connect to a single gateway, according to embodiments of the disclosure. FIG. 18C depicts a third positioning architecture 1840 where multiple satellites connect to multiple gateways, according to embodiments of the disclosure. FIG. 18D depicts a fourth positioning architecture 1845 of multi-connectivity involving transparent NTN-based NG-RAN and cellular NG-RAN, according to embodiments of the disclosure. In the case of distributed gNB architecture, each satellite may host the gNB-DU, while a serving NTN gateway hosts the gNB-CU.

In a first implementation, a target UE is connected to a single satellite through a service link. In FIG. 17A, the satellite 1710 is connected to the NTN gateway 1715 through a feeder link, where the NTN gateway 1715 is further connected to the serving LMF 1730 via the serving AMF 1725 through an NG-C interface. In case of a transparent payload, the NTN gateway 1715 may act as a gNB or is further connected to a gNB 1720, as shown in FIG. 17A.

Alternatively, in the case of regenerative payload NTN architecture, the serving satellite 1810 may be considered as a serving gNB, where partial or full gNB capability is supported at the serving satellite 1810. Here, the UE 1805 is connected to a single satellite 1810 through a service link, the satellite 1810 is connected to the NTN gateway 1715 through a feeder link, and the NTN gateway 1815 can act as a transport-layer node and further connect to the serving LMF 1830 via the serving AMF 1825, as shown in FIG. 18A. In both transparent NTN and regenerative NTN cases, the positioning calculations are performed at the core network through the NTN gateway 1715, 1815 and are based on a single node connectivity.

In a second implementation, a target UE is connected to multiple satellites where all satellites are connected through the same NTN gateway for both transparent and regenerative payloads, as shown in FIGS. 17B and 18B, respectively. In FIG. 17B, the target UE 1705 is connected to at least two satellites 1710, 1712 through service links, with the satellites 1710, 1712 each being connected to the same NTN gateway 1715 through feeder links. The NTN gateway 1715 is further connected to the serving LMF 1730 via the serving AMF 1725 through an NG-C interface. In case of a transparent payload, the NTN gateway 1715 may act as a gNB or is further connected to a gNB 1720, as shown in FIG. 17A.

Alternatively, in the case of regenerative payload NTN architecture, the serving satellites 1810, 1812 may be considered as serving gNBs, where partial or full gNB capability is supported at the serving satellites 1810, 1812. Here, the UE 1805 is connected to at least two satellites 1810, 1812 through service links, the satellites 1810, 1812 are connected to the NTN gateway 1715 through feeder links, and the NTN gateway 1815 can act as a transport-layer node and further connect to the serving LMF 1830 via the serving AMF 1825, as shown in FIG. 18B. In both transparent NTN and regenerative NTN cases, the positioning calculations are performed at the core network and are based on multi-satellite feedback through a single NTN gateway 1715, 1815. Note that in the case of transparent payload, the positioning is based on a single gNB with multiple satellite connectivity, while for the case of regenerative payload, the position is based on multi-gNB connectivity.

In a third implementation, a target UE is connected to multiple satellites of same orbital constellation or different orbital constellations, e.g., LEO-LEO, LEO-MEO, or LEO-GEO, where satellites may have different gateways. Each gateway is connected to the serving LMF via same AMF for both transparent and regenerative payload, as shown in FIGS. 17C and 18C, respectively. In FIG. 17C, the target UE 1705 is connected to at least two satellites 1710, 1712 through service links, with each satellites 1710, 1712 belonging to a different orbital constellation, and thus connected to different NTN gateways 1715, 1717 through feeder links. The NTN gateways 1715, 1717 are further connected to the serving LMF 1730 via the serving AMF 1725 through an NG-C interface. In case of a transparent payload, each NTN gateway 1715, 1717 may act as a gNB or may be connected to a gNB 1720, 1722, as shown in FIG. 17C.

Alternatively, in the case of regenerative payload NTN architecture, the serving satellites 1810, 1812 may be considered as serving gNBs, where partial or full gNB capability is supported at the serving satellites 1810, 1812. Here, the UE 1805 is connected to at least two satellites 1810, 1812 through service links, the satellites 1810, 1812 are each connected to a different NTN gateway 1815, 1817 through feeder links. The respective NTN gateways 1815, 1817 can act as a transport-layer node and further connect to the serving LMF 1830 via the serving AMF 1825 through an NG-C interface, as shown in FIG. 18C. In both transparent NTN and regenerative NTN cases, the positioning calculations are performed at the core network and are based on multi-satellite feedback through multiple NTN gateways. For both transparent payload and regenerative payload scenarios, the positioning is based on multiple gNBs connected to multiple satellites of same or different NTN orbital constellations.

In case of multi-connectivity involving transparent or regenerative NTN-based NG RAN and cellular (i.e., terrestrial network (“TN”)) NG-RAN, the TN-based gNB and NTN gateway (one or multiple) are connected to the same LMF via the AMF, as shown in FIGS. 17D and 18D for transparent and regenerative payloads, respectively. In either scenario, one or multiple gateways can further be connected to one or multiple satellites of same or different orbital constellations. The positioning is based on number of satellites connections and the number of TN gNB connections to the same AMF.

In the FIG. 17D, the target UE 1705 is connected to at least two satellites 1710, 1712 through service links, with each satellites 1710, 1712 belonging to the same or different orbital constellation. In the depicted embodiment, it is assumed that the satellites 1710, 1712 belong to the same orbital constellation and are thus connected to the same NTN gateway 1715 through feeder links. In addition to the NTN connections, the target UE 1705 may establish a connection to a TN gNB 1750. The NTN gateway 1715 and TN gNB 1750 are connected to one another through a Xn interface, and are further connected to the serving LMF 1730 via the serving AMF 1725 through the NG-C interface. In case of a transparent payload, each NTN gateway 1715 may act as a gNB or may be connected to a gNB 1720, as shown in FIG. 17D.

Alternatively, in the case of regenerative payload NTN architecture, the serving satellites 1810, 1812 may be considered as serving gNBs, where partial or full gNB capability is supported at the serving satellites 1810, 1812. Here, the UE 1805 is connected to at least two satellites 1810, 1812 through service links, the satellites 1810, 1812 are each connected to a different NTN gateway 1815, 1817 through feeder links. In addition to the NTN connections, the target UE 1805 may establish a connection to a TN gNB 1850. The respective NTN gateways 1815, 1817 can act as a transport-layer node. The NTN gateways 1815 and the TN gNB 1850 are further connected to the serving LMF 1830 via the serving AMF 1825 through the NG-C interface, as shown in FIG. 18D. In both transparent NTN and regenerative NTN cases, the positioning calculations are performed at the core network and are based on multi-satellite feedback through multiple NTN gateways. For both transparent payload and regenerative payload scenarios, the positioning is based on multiple gNBs connected to multiple satellites of same or different NTN orbital constellations.

Solution 1-2 relates to multi-connectivity NTN positioning architecture based on the serving and non-serving LMF. According to solution 1-2, multiple gateways in an NTN network are connected to the different LMFs via different AMFs, where each gateway may support one or multiple satellites in one orbital constellation (LEO-LEO, MEO-MEO, GEO-GEO) or multiple orbital constellations (LEO-MEO, LEO-GEO, etc.). In such case, one AMF/LMF acts as the serving AMF/LMF, while other AMF/LMF acts as neighboring AMF/LMF and assists in performing target-UE positioning.

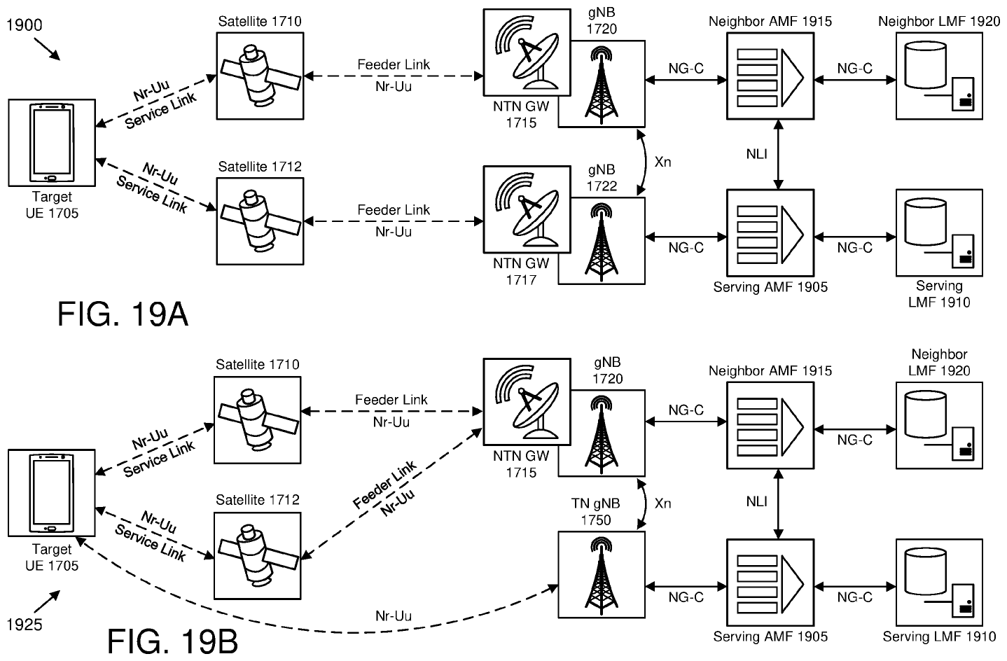

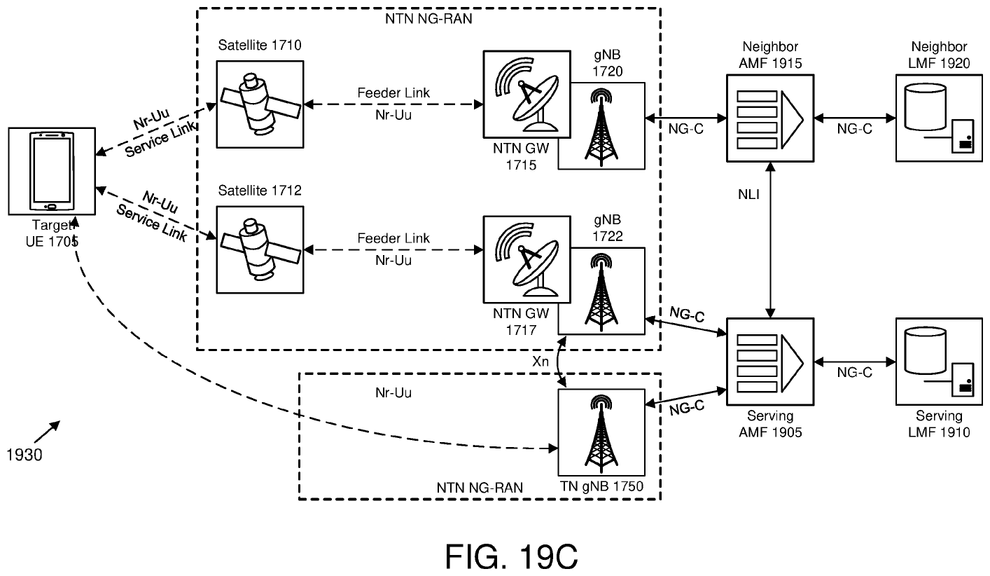

FIGS. 19A-19C depict different positioning architectures based on serving and neighboring LMF using transparent NTN system. FIG. 19A depicts a transparent payload positioning architecture 1900 for multi-connectivity within NTN-based NG-RAN, according to embodiments of the disclosure. FIG. 19B depicts a transparent payload positioning architecture 1925 implementing a first option (Option 1) of multi-connectivity involving NTN-based NG-RAN and TN-based NG-RAN, according to embodiments of the disclosure. FIG. 19C depicts a transparent payload positioning architecture 1930 implementing a second option (Option 2) of multi-connectivity involving NTN-based NG-RAN and TN-based NG-RAN, according to embodiments of the disclosure.

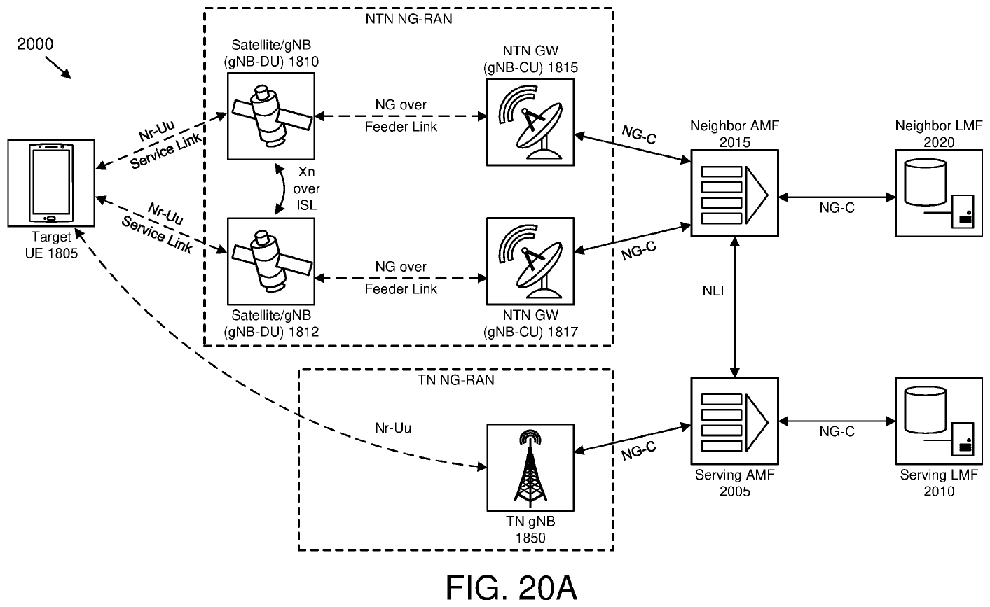

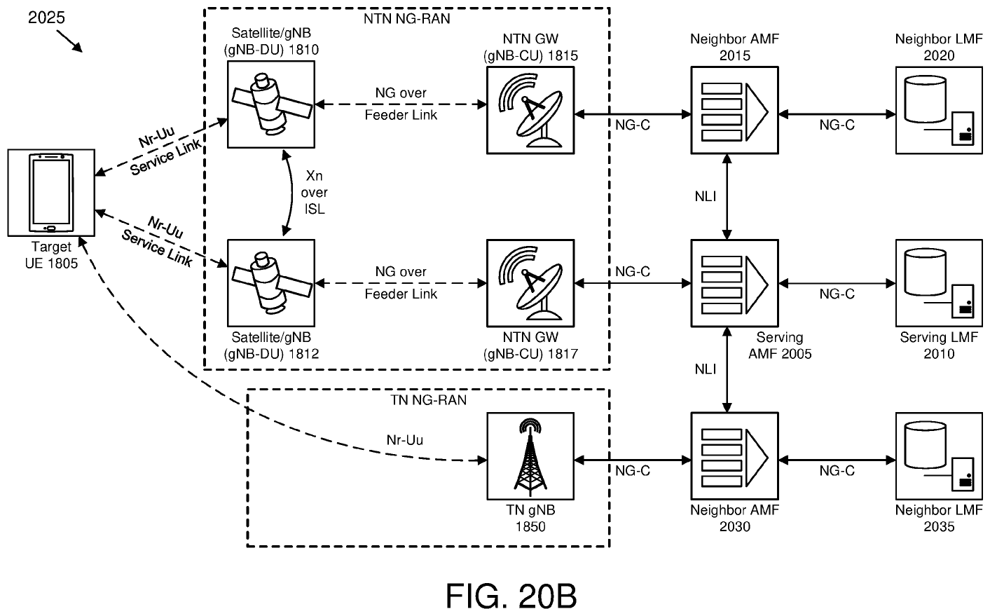

FIGS. 20A-20B depict different positioning architectures based on serving and neighboring LMF using regenerative NTN system. FIG. 20A depicts a regenerative payload positioning architecture 2000 implementing a first option (Option 1) for multi-connectivity involving NTN-based NG-RAN and TN-based NG-RAN, according to embodiments of the disclosure. FIG. 20B depicts a regenerative payload positioning architecture 2025 implementing a second option (Option 2) for multi-connectivity involving NTN-based NG-RAN and TN-based NG-RAN, according to embodiments of the disclosure.

In one implementation, when multi-connectivity is supported by an NTN NG-RAN architecture, one NTN gateway is connecting to the AMF/LMF and acts as a serving AMF/LMF while one or multiple other NTN gateways are connected to one or multiple AMFs/LMFs that act as neighboring AMFs/LMFs. Depending upon the transparent or regenerative payload, the NTN gateway may act as a gNB or as a transport layer node. An illustration of such architecture for transparent payload is shown in FIG. 19A.

FIG. 19A depicts a positioning architecture 1900 for multi-connectivity within NTN-based NG-RAN, and is a modification of the architecture 1740 depicted in FIG. 17C. In FIG. 19A, the target UE 1705 is connected to at least two satellites 1710, 1712 through service links, with each satellites 1710, 1712 belonging to a different orbital constellation, and thus connected to different NTN gateways 1715, 1717 through feeder links. The NTN gateways 1715, 1717 are connected to one another through a Xn interface. The NTN gateway 1717 is connected to the serving LMF 1910 via the serving AMF 1905 though an NG-C interface. The NTN gateway 1715 is connected to the neighboring LMF 1920 via the neighboring AMF 1915 through an NG-C interface. In case of a transparent payload, each NTN gateway 1715, 1717 may act as a gNB or may be connected to a gNB 1720, 1722, as shown in FIG. 19A.

In another implementation, when multi-connectivity involves NTN-based NG-RAN and terrestrial network (“TN”) based NG-RAN, one or multiple NTN gateways (gNBs) are connected to a single AMF/LMF that act either as serving AMF/LMF or as neighboring AMF/LMF. The cellular (i.e., TN) gNB is connected to a different AMF/LMF that may act as either a serving AMF/LMF or as neighboring AMF/LMF. An illustration of such positioning architecture is shown in FIGS. 19B and 20A for transparent and regenerative payloads, respectively.

FIG. 19B depicts the positioning architecture 1925 for multi-connectivity involving both NTN-based NG-RAN and TN-based NG-RAN, and is a modification of the architecture 1745 depicted in FIG. 17D. In the FIG. 19B, the target UE 1705 is connected to at least two satellites 1710, 1712 through service links, with each satellites 1710, 1712 belonging to the same or different orbital constellation. In the depicted embodiment, it is assumed that the satellites 1710, 1712 belong to the same orbital constellation and are thus connected to the same NTN gateway 1715 through feeder links. In addition to the NTN connections, the target UE 1705 may establish a connection to a TN gNB 1750. The NTN gateway 1715 and TN gNB 1750 are connected to one another through a Xn interface. The TN gNB 1750 is connected to the serving LMF 1910 via the serving AMF 1905 though an NG-C interface. The NTN gateway 1715 is connected to the neighboring LMF 1920 via the neighboring AMF 1915 through an NG-C interface. In case of a transparent payload, the NTN gateway 1715 may act as a gNB or may be connected to a gNB 1720, as shown in FIG. 19B.

FIG. 20A depicts the positioning architecture 2000 for multi-connectivity involving both NTN-based NG-RAN and TN-based NG-RAN, and is a modification of the architecture 1845 depicted in FIG. 18D. In the FIG. 20A, the target UE 1805 is connected to at least two satellites 1810, 1812 through service links, with each satellites 1810, 1812 belonging to different orbital constellation. In the case of regenerative payload NTN architecture, the serving satellites 1810, 1812 may be considered as serving gNBs, where partial or full gNB capability is supported at the serving satellites 1810, 1812. The satellites 1810, 1812 are connected to one another through a Xn interface and are each connected to a different NTN gateway 1815, 1817 through feeder links. In addition to the NTN connections, the target UE 1805 may establish a connection to a TN gNB 1850. The respective NTN gateways 1815, 1817 can act as a transport-layer node. The TN gNB 1850 is connected to the serving LMF 2010 via the serving AMF 2005 through the NG-C interface, while the NTN gateways 1815, 1817 are further connected to the neighboring LMF 2020 via the neighboring AMF 2015 through an NG-C interface, as shown in FIG. 20A.

In another implementation, when multi-connectivity involves NTN-based NG-RAN and TN-based NG-RAN, a cellular gNB and an NTN gNB (gateway) may connect to same AMF/LMF that may act either as serving AMF/LMF or as neighboring AMF/LMF, while other connected gNBs (gateways) may act as either of serving AMF or as neighboring AMF/LMF. An illustration of such positioning architecture is shown in FIG. 19C for transparent payloads.

FIG. 19C depicts the positioning architecture 1930 for multi-connectivity involving both NTN-based NG-RAN and TN-based NG-RAN, and is a modification of the architecture 1745 depicted in FIG. 17D. In the FIG. 19C, the target UE 1705 is connected to at least two satellites 1710, 1712 through service links. In the depicted embodiment, it is assumed that the satellites 1710, 1712 belong to different orbital constellation and are thus connected to the different NTN gateway 1715, 1717 through feeder links. In addition to the NTN connections, the target UE 1705 may establish a connection to a TN gNB 1750. The NTN gateway 1717 and TN gNB 1750 are connected to one another through a Xn interface. The NTN gateway 1717 and TN gNB 1750 are connected to the serving LMF 1910 via the serving AMF 1905 though an NG-C interface. The NTN gateway 1715 is connected to the neighboring LMF 1920 via the neighboring AMF 1915 through an NG-C interface. In case of a transparent payload, the NTN gateway 1715 may act as a gNB or may be connected to a gNB 1720, as shown in FIG. 19C.

In another implementation, in the multi-connected NTN-based NG-RAN and TN-based NG-RAN systems, each gNB is connected to a different AMF/LMF. Only one of these AMF/LMF act as serving AMF/LMF while all other act as neighboring AMF/LMF, as shown in FIG. 20B.

FIG. 20B depicts the positioning architecture 2025 for multi-connectivity involving both NTN-based NG-RAN and TN-based NG-RAN, and is a modification of the architecture 1845 depicted in FIG. 18D. In the FIG. 20B, the target UE 1805 is connected to at least two satellites 1810, 1812 through service links, with each satellites 1810, 1812 belonging to different orbital constellation. In the case of regenerative payload NTN architecture, the serving satellites 1810, 1812 may be considered as serving gNBs, where partial or full gNB capability is supported at the serving satellites 1810, 1812. The satellites 1810, 1812 are connected to one another through a Xn interface over ISL and are each connected to a different NTN gateway 1815, 1817 through feeder links. The respective NTN gateways 1815, 1817 can act as a transport-layer node. In addition to the NTN connections, the target UE 1805 may establish a connection to a TN gNB 1850. As shown in FIG. 20B, the NTN gateway 1817 is connected to the serving LMF 2010 via the serving AMF 2005 through the NG-C interface. The NTN gateway 1817 is connected to the neighboring LMF 2020 via the neighboring AMF 2015 through an NG-C interface, while the TN gNB 1850 is connected to the neighboring LMF 2035 via the neighboring AMF 2030 through the NG-C interface.

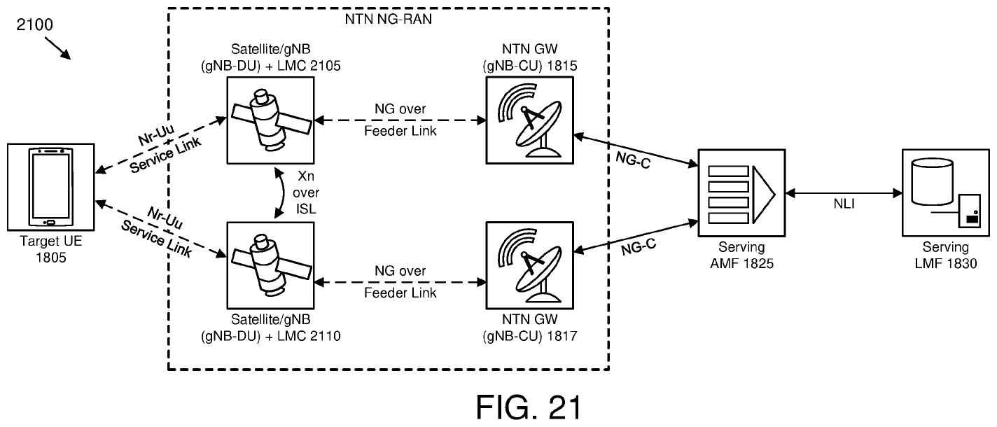

Solution 1-3 relates to regenerative-payload satellite gNB with LMC functionality. According to solution 1-3, one or multiple satellites with regenerative payloads may be embedded with LMC functionality. The LMC may comprise of all or part of the LMF and can reside in the NG-RAN. In another implementation, the LMC can comprise a Location Measurement Unit (“LMU”), which may perform and process positioning measurements, perform associated computations of these measurements, request and report applicable positioning measurements based on supported positioning methods or combinations thereof. An example of such architecture is shown in FIG. 21.

FIG. 21 depicts a positioning architecture 2100 for multiple satellites connect to multiple gateways having LMC as part of gNB for regenerative NTN system, according to embodiments of the disclosure. The architecture 2100 is a modification of the architecture 1840 depicted in FIG. 18C. In the FIG. 21, the target UE 1805 is connected to at least two satellites 2105, 2110 through service links, with each satellites 2105, 2110 belonging to different orbital constellation. In the case of regenerative payload NTN architecture, the serving satellites 2105, 2110 may be considered as serving gNBs, where partial or full gNB capability is supported at the serving satellites 2105, 2110.

According to solution 1-3, the satellite 2105, 2110 each are embedded with LMC functionality. The satellites 2105, 2110 are connected to one another through a Xn interface over ISL and are each connected to a different NTN gateway 1815, 1817 through feeder links. The respective NTN gateways 1815, 1817 can act as a transport-layer node and are further connected to the serving LMF 1830 via the serving AMF 1825 through an NG-C interface, as shown in FIG. 21.

In an alternative implementation, the NTN gateways 1815, 1817 may be connected to different AMFs and LMFs, as discussed in solutions 1-1 and 1-2. Note that different options/alternatives that are discussed in FIGS. 18A-18D and 20A-20B can be modified to use similar architecture. In case of transparent payload, the NTN gateways may act as gNB and so this LMC functionality may be embedded in the NTN gateways (e.g., NTN gateways 1715, 1717).

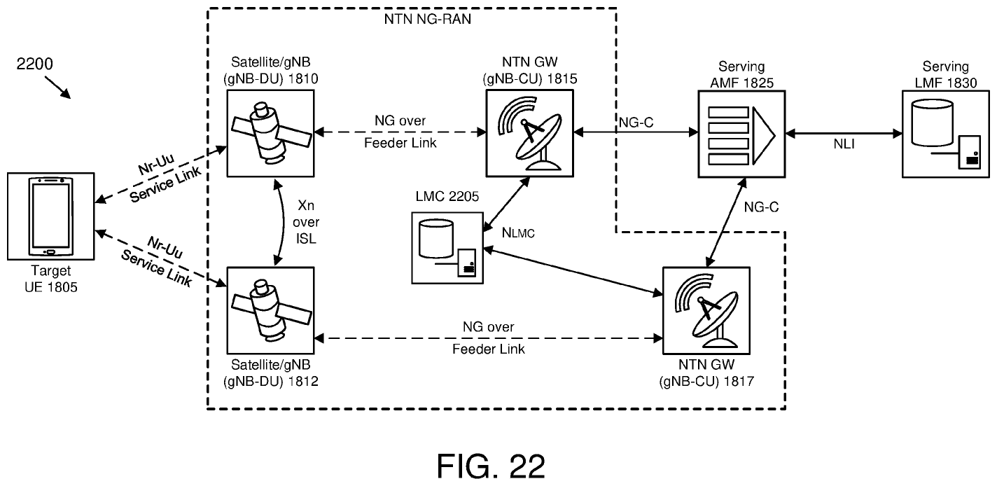

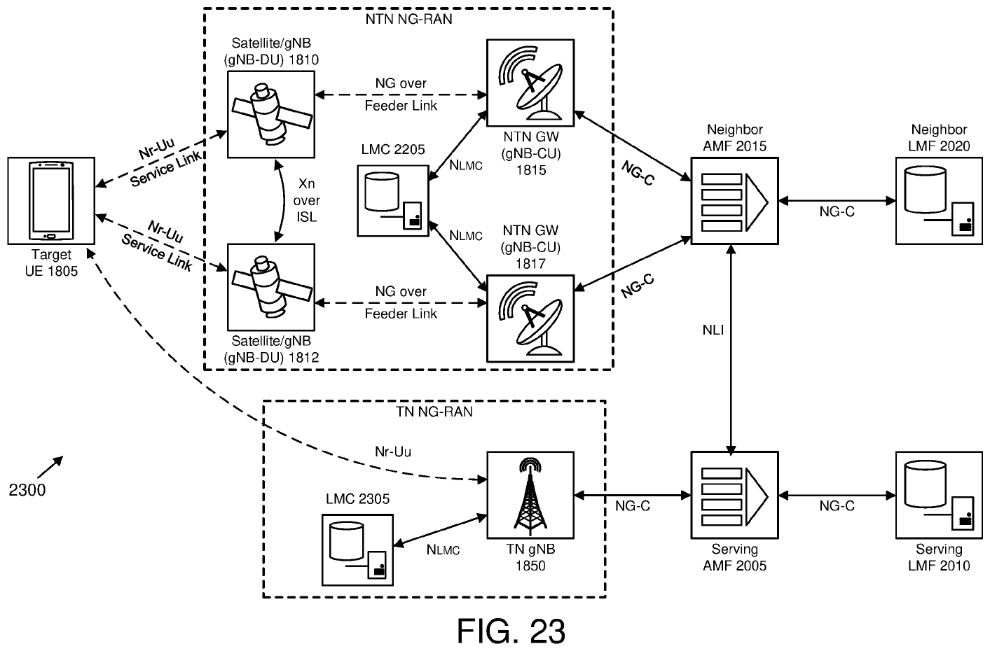

According to solution 1-4, two or more gateways in an NTN system may be connected to a new LMC entity/node via the newly proposed interfaces (NLLMC). Similar to the embodiment 1-3, the LMC may comprise of all or part of the LMF and can reside in the NG-RAN. Such implementation may be applied to both transparent and regenerative NTN systems. An example of such an architecture is shown in FIGS. 22-23 that use regenerative NTN systems. It is noteworthy that architectures described in different embodiments may be combined. For example, in addition to LMC connected to gateways, the gateways may further be connected as described in embodiments 1-1 and 1-2, as shown in FIGS. 22-23.

FIG. 22 depicts a positioning architecture 2200 for multiple satellites connected to multiple gateways having LMC as part of gNB for regenerative NTN system, according to embodiments of the disclosure. The architecture 2200 is a modification of the architecture 1840 depicted in FIG. 18C. In the FIG. 22, the target UE 1805 is connected to at least two satellites 1810, 1812 through service links, with each satellites 1810, 1812 belonging to different orbital constellation. In the case of regenerative payload NTN architecture, the serving satellites 1810, 1812 may be considered as serving gNBs, where partial or full gNB capability is supported at the serving satellites 1810, 1812. The satellites 1810, 1812 are connected to one another through a Xn interface over ISL and are each connected to a different NTN gateway 1815, 1817 through feeder links.

According to solution 1-4, the NTN gateways 1815, 1817 are communicatively coupled to an LMC node 2205. The respective NTN gateways 1815, 1817 can act as a transport-layer node and are further connected to the serving LMF 1830 via the serving AMF 1825 through an NG-C interface, as shown in FIG. 22.

In an alternative implementation, the NTN gateways 1815, 1817 may be connected to different AMFs and LMFs, as discussed in solutions 1-1 and 1-2. Note that different options/alternatives that are discussed in FIGS. 18A-18D and 20A-20B can be modified to use similar architecture. In case of transparent payload, the NTN gateways 1715, 1717 and/or gNBs 1720, 1722 may be communicatively coupled to an LMC node.

FIG. 23 depicts a positioning architecture 2300 for multiple satellites connected to multiple gateways having LMC as part of gNB for regenerative NTN system, according to embodiments of the disclosure. The architecture 2300 is a modification of the architecture 2000 depicted in FIG. 20A. In the FIG. 23, the target UE 1805 is connected to at least two satellites 1810, 1812 through service links, with each satellites 1810, 1812 belonging to the same orbital constellation. In the case of regenerative payload NTN architecture, the serving satellites 1810, 1812 may be considered as serving gNBs, where partial or full gNB capability is supported at the serving satellites 1810, 1812. The satellites 1810, 1812 are connected to one another through a Xn interface over ISL and are each connected to a different NTN gateway 1815, 1817 through feeder links. The respective NTN gateways 1815, 1817 can act as a transport-layer node. According to solution 1-4, the NTN gateways 1815, 1817 are communicatively coupled to an LMC node 2205.

In addition to the NTN connections, the target UE 1805 may establish a connection to a TN gNB 1850. According to solution 1-4, the TN gNB 1850 is communicatively coupled to an LMC node 2305. Moreover, the TN gNB 1850 is connected to the serving LMF 2010 via the serving AMF 2005 through the NG-C interface, while the NTN gateways 1815, 1817 are further connected to the neighboring LMF 2020 via the neighboring AMF 2015 through an NG-C interface, as shown in FIG. 23.

In an alternative implementation, the NTN gateways 1815, 1817 may be connected to different AMFs and LMFs, as discussed in solutions 1-1 and 1-2. Note that different options/alternatives that are discussed in FIGS. 18A-18D and 20A-20B can be modified to use similar architecture. In case of transparent payload, the NTN gateways 1715, 1717 and/or gNBs 1720, 1722 may be communicatively coupled to an LMC node.

The second solution relates to Supported Triggered Location Requests over NTN. The embodiments of the second solution outline the type of location requests that can be supported and considered feasible over NTN. These depend on the PLMN service areas associated with NTN connectivity and the wireless communication services offered by, e.g., an operator, which can be area-specific, region-specific, country-specific, etc. There are several cases to consider when describing the type of location requests to be supported by NTN-LCS positioning framework. The NTN-LCS architecture can distinguish the following, which can be supported for the options listed in FIGS. 17-23.

Regarding Network Induced Location Request (NI-LR), the serving AMF for a target UE initiates location estimation of the UE for based on a trigger, e.g. a regulatory service (e.g., an emergency call from the target UE). Depending on the transparent or regenerative NTN-LCS architecture options listed in FIGS. 19-23, the serving or neighboring AMF may trigger the location request depending on the:
Mobility pattern of the target UE, which can be historical or predictive based on the capabilities of the network
Mobility pattern of the satellites, which can be historical or predictive based on the capabilities of the network
Type of feeder link handover procedure, i.e., hard, or soft feeder link switch over
Type of beam layout architecture in the cell, i.e., earth moving cell/beams and earth fixed cells/beams

Regarding Mobile Terminated Location Request (“MT-LR”), the LCS client or AF external to or internal to a serving PLMN sends a location request to the PLMN (which may be the Home PLMN or Visiting PLMN) for the location of a target UE. The PLMN consists of the mobile network operators service area and may include a combination of Terrestrial Network (“TN”), Non-Terrestrial Network (“NTN”) or combination thereof.

Regarding Mobile Originated Location Request (“MO-LR”), the UE sends a request to a serving PLMN for location related information for the target UE. The serving PLMN may include a TN, NTN, or combination thereof.

Regarding Immediate location request, the LCS client or AF sends or instigates a location request for a target UE (or group of target UEs) and expects to receive a response containing location information for the target UE (or group of target UEs) within a configured time duration period, which may be specified using QoS indicators.

This time duration can be configured based on the NTN coverage area, satellite orbital positions and mobility, and associated network architecture. In one embodiment, the time period for response is also indicated along with the location request. The supported positioning QoS may include horizontal and vertical accuracy, which can be both absolute and relative, confidence interval of the positioning estimate, positioning integrity and reliability including Alert limit (“AL”), Time-to-alert (“TTA”) and Target Integrity Risk (“TIR”), desired E2E latency (e.g., time-to-first-fix (“TTFF”) and/or response time), horizontal and vertical velocity accuracy, and confidence intervals.

Regarding Deferred Location Request, similar to Immediate Location Request, but the LCS client/AF expects to receive a response containing the indication of event occurrence and location information if requested for the target UE (or group of target UEs) at some future time (or times), which may be associated with specific events. This can be supported for all types of requests including NI-LR, MO-LR and MT-LR. The following events are to be supported based on the target UE behavior in an NTN-LCS positioning framework:

Coverage area: This event is based on whether the target UE enters, leaves, or remains within a pre-defined geographical area, which can be either in-coverage, partial coverage or out of coverage of network or LEO satellites or combination thereof. At least one type of area event can be defined (i.e., entering, leaving, or remaining within the area). An exemplary area event may include entering or leaving an NTN cell. The LCS client or AF may define the target area as a geographical area or as a geopolitical name of an area or based on predefined zones of configured lengths. Area event reporting is controlled by configuring a minimum and a maximum reporting time threshold. The minimum reporting time defines the minimum allowed time between successive area events. The maximum reporting time defines the maximum time between successive reports. When a UE transmits a report due to expiration of the maximum reporting time, the UE indicates expiration of the maximum reporting time as the trigger event. The maximum reporting time enables the AF, LCS client and/or Home GMLC to remain aware of continuing support by the target UE for the area event (e.g., to detect if area event reporting may have been aborted due to target UE power off).

Periodic Absolute and Relative Location: This event is based on a configured periodic timer by the network or target UE and expires in the UE, which activates the transmission of location report of a target UE or a set of multiple target UEs. If a periodic event is detected by the target UE but an event report cannot be sent (e.g., because the target UE cannot access the network temporarily), a deferred relative location report can be transmitted a later stage and the periodic timer for the next event shall then be started associated with timestamp and location stamp associated with the report. The reporting duration for periodic location shall equal the requested number of reports multiplied by the periodic interval even when reports are delayed.

Tracking/Motion: An event where the target UE deviates from predefined straight-line distance from a previous reported location. In another embodiment, the target UE may deviate from a set of predefined motions, e.g. moving along a curved arc, changing altitudes based on certain height thresholds. The motion event may be reported one time only, or multiple times. The motion event report shall contain an indication of the event occurrence. A location estimate may be included in the report if requested by the LCS client or Application Function (AF). For successive motion event reports, motion is determined relative to the network, e.g., serving or neighboring gNBs corresponding to the immediately preceding event report (including an event report triggered by expiration of the maximum reporting time). In other implementations, the motion event is determined relative to LEO satellites. If a motion event is detected by target UE but an event report is deferred (e.g., because the target UE cannot access the TN or NTN network temporarily), a report shall be sent later, when possible, irrespective of whether the motion event still applies to the current UE location. Motion reporting is controlled by a configured minimum and a maximum reporting threshold time. The minimum reporting time defines the minimum allowed time between successive event reports. The maximum reporting time defines the maximum time between successive reports. The maximum reporting time enables the application function, LCS client and Home GMLC to remain aware of continuing support by the target UE for the motion event (e.g., to detect if motion event reporting may have been aborted due to target UE power off).

Regarding a Network Induced Location Request (“NI-LR”), in some embodiments, a serving AMF for a UE initiates a location service of the UE, for example for a regulatory service (e.g., an emergency call from the target UE). Then, a serving AMF or a neighboring AMF may trigger the location request. Different factors may affect the location request as listed below.

In an embodiment, the location request may be based on a mobility pattern of the UE, which may be historical, predictive, or a combination thereof, based on the capabilities of the network. For example, a location of a handheld device may be initiated more frequently because of its unpredictable and possibly sudden movement compared to a receiver onboard a train with more regular and predictable movement.

In another embodiment, a mobility pattern of a satellite, or any other non-terrestrial transmit-receive point (“NT-TRP”), may affect the location request, which may be historical or predictive based on the capabilities of the network. In the case of Geostationary Earth Orbiting (“GEO”) satellites, the satellite's movement as observed by a UE on the ground is fixed (geostationary) or possibly have a relatively small movement (geo-synchronous). Alternatively, in the case of LEO or MEO satellites, the movement of the satellite is fully predictable and continuously obtained and updated by measurements on the satellite and on the ground. However, what may change, which may affect the accuracy of a positioning process at a moment, is whether the satellite has a line of sight towards the UE. In a typical urban area, that may change frequently as the satellite may appear and disappear frequently due to obstruction by buildings and other obstacles. Finally, in the case of High-Altitude Platform Station (“HAPS”) and Uncrewed Aerial Vehicle (“UAV”), the movement of the satellite may not be predictable, hence requiring potentially an adaptive timing for sending location requests.

In yet another embodiment, a location request may be affected by a type of a feeder link switchover procedure, i.e., hard or soft feeder link switchover. In the case of hard switchover, the switchover may trigger a location request. In the case of LEO and MEO satellites, the location request may be sent before and/or after the switchover, i.e., within a time threshold before and/or after the switchover. A predictive location request prior to the switchover is possible in the case of LEO and/or MEO satellites as the trajectory of the satellite's movement may be predicted with fine accuracy, hence allowing to predict the resulting channel state associated with the feeder link and the timing needed to perform the switchover in order to maintain a certain channel quality for the feeder link.

In yet another embodiment, triggering a location request may be affected by type of beam layout architecture in the cell, i.e., an earth-moving cell/beam versus an earth-fixed cells/beam. For example, if an earth-moving cell/beam is Doppler pre-compensated by a constant value of Doppler offset, a location request may be triggered at relative regular intervals. Conversely, in the case of an earth-fixed cell/beam, different values of Doppler offset may be applied to different satellite beams (as the satellite moves and yet attempts to fix a beam on the ground), hence triggering a location request every time that a different satellite beam is applied.

In yet another embodiment, a combination of the above may affect a decision to trigger a location request. In one implementation, instead of a movement of the UE or a movement of the satellite/NT-TRP, a relative movement may be considered. For example, a UE onboard a fast train traveling approximately in the direction of the movement of the satellite may trigger a location request less frequently compared to a UE onboard a fast train that travels in an opposite direction.

Regarding a Mobile Terminated Location Request (“MT-LR”), in some embodiments, an LCS client or an AF, which may be external or internal with respect to a serving PLMN, sends a location request to the PLMN. The PLMN may be a Home PLMN or a Visiting PLMN for the location of a target UE. The PLMN consists of the mobile network operators service area.

Similar to the case of NI-LR, in various embodiments, triggering a location request may be affected or determined by at least one of a target UE movement, a satellite/NT-TRP movement pattern, a type of feeder link switchover, a type of beam layout, or a combination thereof.

Regarding a Mobile Originated Location Request (“MO-LR”), in some embodiments, a UE sends a location request to a serving PLMN for a location related information for the UE. Similar to the case of NI-LR and MT-LR, in various embodiments, triggering a location request may be affected or determined by at least one of a UE movement, a satellite/NT-TRP movement pattern, a type of feeder link switchover, a type of beam layout, or a combination thereof.

Regarding an immediate location request, in some embodiments, an LCS client or an AF sends or instigates a location request for a target UE (or a group of target UEs) and expects to receive a response comprising location information for the target UE (or the group of target UEs) within a configured time duration. The time duration may be determined by a QoS metric such as a QoS index.

In various embodiments, the said time duration may be configured based on a satellite (or generally, an NT-TRP) coverage area, satellite ephemeris, a satellite orbit, a mobility pattern, a time duration expected for the satellite during which the satellite is above a certain angle from the horizon from the viewpoint of the target UE, an expected or minimum or maximum time duration between two consecutive feeder link switchovers, an associated network architecture, or a combination thereof.

In one embodiment, a longer time duration is configured for a larger coverage area, while a shorter time duration is configured for a smaller coverage area. In another embodiment, a longer or shorter duration may be configured based on whether a mobility pattern of the NT-TRP is predictable (e.g., a GEO/MEO/LEO satellite) or unpredictable (e.g., a HAPS or a UAV).

In yet another embodiment, a longer of shorter time duration may be configured based on whether and/or where an LMC is realized in the network. Additionally, or alternatively, a time duration may be configured based on the realized position method, an expected or minimum or maximum number of satellites/NT-TRPs available for positioning, and so on.

In one implementation, the time duration may be fixed. In another implementation, a pattern of time durations or an adaptive time duration based on one or multiple of the above criteria may be configured. The pattern may be determined by a configuration, a lower layer signaling, a standard specification, or a combination thereof. In some embodiments, a time duration for a response may additionally, or alternatively, be indicated along with the location request.

In some embodiments, a supported positioning QOS may include horizontal and/or vertical accuracy (absolute or relative), a confidence interval of a positioning estimate, a positioning integrity and reliability parameter such as AL, TTA and TIR, desired E2E latency (TTFF and/or response time), horizontal and vertical velocity accuracy, and confidence intervals.

A deferred location request is similar to an immediate location request described above. However, the LCS client or AF may expect to receive a response comprising the indication of event occurrence and location information if requested for the target UE (or the group of target UEs) at one or multiple specific times, which may be associated with specific events. This may be supported for all types of requests including NI-LR, MO-LR and MT-LR. The following events are to be supported based on the target UE behavior in an NTN-LCS positioning framework.

Regarding Coverage Area, this event is based on whether the target UE enters, leaves, or remains within a predefined geographical area, which may be either in-coverage, partial coverage or out of coverage of network or satellites or combination thereof.

In some embodiment, an area event is defined as entering, leaving, and/or remaining within an area. An exemplary area event may include entering or leaving an NT-TRP cell or beam. The LCS client or Application function may define the target area as a geographical area or as a geopolitical name of an area or based on predefined zones of configured lengths. In one implementation, an area may be defined based on a cell coverage of an NT-TRP before an expected or minimum or maximum time of a feeder link switchover. In another implementation, an area may be defined based on a minimum angle of the NT-TRP from the horizon as seen by an observer on the ground, which may be affected by an altitude of a LEO or MEO satellite, for example.

An area event reporting is controlled by configuring a minimum and/or a maximum reporting time threshold. The minimum reporting time defines the minimum allowed time between successive area events. The maximum reporting time defines the maximum time between successive reports. When a target UE transmits a report due to expiration of the maximum reporting time, the UE indicates expiration of the maximum reporting time as the trigger event. The maximum reporting time enables the Application Function, LCS client and/or Home GMLC to remain aware of continuing support by the target UE for the area event (e.g., to detect if area event reporting may have been aborted due to target UE power off).

Regarding Periodic Absolute and Relative Location, this event is based on a configured periodic timer by the network or the UE, and expires in the UE, which activates the transmission of location report of a target UE or a group of target UEs. If a periodic event is detected by the target UE, but an event report cannot be sent (e.g., because the target UE cannot access the network temporarily), a deferred relative location report can be transmitted at a later stage and the periodic timer for the next event shall be started in association with a timestamp and/or a location stamp associated with the report. The reporting duration for a periodic location request may be equal to the requested number of reports multiplied by the periodic interval. This formula may be maintained even when reports are delayed.

Regarding Tracking/Motion, an event may be defined based on whether the target UE deviates from a predefined course with respect to previous one or multiple previously reported location(s). A tolerance interval may be determined within which a deviation may not trigger a location request. This tolerance interval may be specified by the standard or configured by the network based on a coverage area, a movement pattern, a positioning measurement accuracy, and so on.

In some embodiments, the target UE may deviate from a set of predefined motions, e.g., moving along a curved arc or changing altitudes based on certain height thresholds, possibly within a tolerance range. The motion event may be reported one or multiple times.

In some embodiments, a motion event report may contain an indication of the event occurrence. A location estimate may be included in the report if requested by the LCS client or Application Function.

For successive motion event reports, motion is determined relative to a network entity, e.g., a serving or neighboring terrestrial or non-terrestrial gNBs corresponding to the immediately preceding event report (including an event report triggered by expiration of the maximum reporting time). In other implementations, the motion event is determined relative to an NT-TRP such as a satellite.

If a motion event is detected by a target UE, but an event report is deferred, for example because the target UE cannot access the network temporarily, a report may be sent later, when possible, irrespective of whether the motion event still applies to the current UE location.

Motion reporting is controlled by a configured minimum and/or a maximum reporting threshold time. The minimum reporting time defines the minimum allowed time between successive event reports. The maximum reporting time defines the maximum time between successive reports. The maximum reporting time enables the application function, LCS client and/or Home GMLC to remain aware of continuing support by the UE for the motion event (e.g., to detect if motion event reporting may have been aborted due to a UE power-off).

A third solution describes the LCS functionality that should be supported by NTN nodes, such as the LEO satellite and gateway (“GW”) entities.

The NG-RAN LCS architecture may reuse the functionality defined in FIGS. 17-18. However, due to the presence of an inherent delay via an NT-TRP such as a satellite, for the location preparation, which may include exchanging capability information, request and response for positioning assistance data, etc., the LMF may request and receive a response on the type of utilized architecture indication, e.g., a field that indicates whether a transparent-payload or a regenerative-payload NG-RAN architecture is being used.

In one implementation, the LMF may request the AMF for such an indication, while in another implementation, the LMF may request the gNB for this indication via the NRPPa (NR Positioning Protocol Annex) interface between the gNB and an LMF. This information may be used by the LMF to select a positioning method and measurements for configuration.

In an extended implementation, the indication may further comprise the following:
A number of LEO satellites that are connected to the same gateway or a different gateway for a particular location session, e.g., an LPP (LTE Positioning Protocol) session.
A number of gateways connected for a particular location session, e.g., an LPP session.

Due to the expected long signaling delays (including round trip time) between the UE and LMF via the NTN NG-RAN architecture, it is beneficial that the full or partial set of LMF functionality be supported by a network comprising an NTN, e.g., LEO satellite. The LMC functionality can reduce the overall system positioning latency, which can improve the TTFF of a target-UE. The full or partial set of LMF functionalities may comprise one or more of the following:
Support a request for a single location received from a serving AMF for a target UE.
Support a request for periodic or triggered location received from a serving AMF for a target UE.
Determine position methods based on UE and PLMN capabilities, QoS, UE connectivity state per access type and LCS Client type.
QoS information like absolute and relative positioning accuracy of the location estimate and velocity may also be determined.
Report UE location estimates directly to a GMLC for periodic or triggered location of a target UE.
Support cancelation of periodic or triggered location for a target UE.
Support the provision of broadcast positioning assistance data to UEs via NG-RAN in ciphered or unciphered (e.g., plaintext) form and forward any ciphering keys to subscribed UEs via the AMF.
Support the provision of dedicated delivery of assistance data (e.g., UE-specific positioning assistance data).
Support processing uplink measurements for the purposes of UL-based positioning methods, e.g., UL-AoA, UL SRS RSRP, UL-RTOA.
Support receiving downlink measurements for the purposes of DL-based positioning methods, e.g., DL-TDOA, DL PRS RSRP, DL-AoD.
The LMU may combine all the received measurements and results and determine a single location estimate for the target-UE via hybrid positioning, which makes use of both RAT-dependent and RAT-independent positioning solutions.

In another implementation, one or multiple NTN gateways may also be connected to an LMC entity with the above-mentioned functionality as illustrated in FIG. 22. In a different implementation, the LMC may also form part of a terrestrial gNB or other fixed nodes such as RoadSide Unit (“RSU”) for Vehicle to Everything (“V2X”), etc. In some implementations, the LMC may operate in a standalone manner without an LMF entity in the same PLMN. In other implementations, the LMC may operate in conjunction with a separate LMF entity of the same PLMN (residing in the 5GC). The LMC may also enable lower signaling e.g., Downlink Control Information (“DCI”), RRC, MAC Control Element (“CE”) to convey the information presented above between the target UE and LMC.

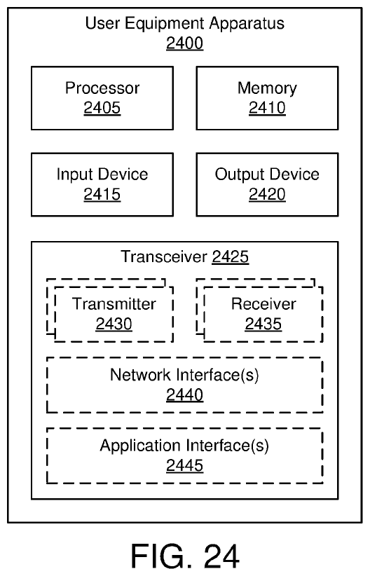

FIG. 24 depicts a user equipment apparatus 2400 that may be used for location services in NTN, according to embodiments of the disclosure. In various embodiments, the user equipment apparatus 2400 is used to implement one or more of the solutions described above. The user equipment apparatus 2400 may be one embodiment of a communication device, such as the remote unit 105 and/or the UE 205, as described above. Furthermore, the user equipment apparatus 2400 may include a processor 2405, a memory 2410, an input device 2415, an output device 2420, and a transceiver 2425.

In some embodiments, the input device 2415 and the output device 2420 are combined into a single device, such as a touchscreen. In certain embodiments, the user equipment apparatus 2400 may not include any input device 2415 and/or output device 2420. In various embodiments, the user equipment apparatus 2400 may include one or more of: the processor 2405, the memory 2410, and the transceiver 2425, and may not include the input device 2415 and/or the output device 2420.

As depicted, the transceiver 2425 includes at least one transmitter 2430 and at least one receiver 2435. In some embodiments, the transceiver 2425 communicates with one or more cells (or wireless coverage areas) supported by one or more base units 121. In various embodiments, the transceiver 2425 is operable on unlicensed spectrum. Moreover, the transceiver 2425 may include multiple UE panels supporting one or more beams. Additionally, the transceiver 2425 may support at least one network interface 2440 and/or application interface 2445. The application interface(s) 2445 may support one or more APIs. The network interface(s) 2440 may support 3GPP reference points, such as Uu, N1, PC5, etc. Other network interfaces 2440 may be supported, as understood by one of ordinary skill in the art.

The processor 2405, in one embodiment, may include any known controller capable of executing computer-readable instructions and/or capable of performing logical operations. For example, the processor 2405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 2405 executes instructions stored in the memory 2410 to perform the methods and routines described herein. The processor 2405 is communicatively coupled to the memory 2410, the input device 2415, the output device 2420, and the transceiver 2425.

In various embodiments, the processor 2405 controls the user equipment apparatus 2400 to implement the above-described UE behaviors. In certain embodiments, the processor 2405 may include an application processor (also known as “main processor”) which manages application-domain and operating system (“OS”) functions and a baseband processor (also known as “baseband radio processor”) which manages radio functions.

The memory 2410, in one embodiment, is a computer readable storage medium. In some embodiments, the memory 2410 includes volatile computer storage media. For example, the memory 2410 may include a RAM, including dynamic RAM (“DRAM”), synchronous dynamic RAM (“SDRAM”), and/or static RAM (“SRAM”). In some embodiments, the memory 2410 includes non-volatile computer storage media. For example, the memory 2410 may include a hard disk drive, a flash memory, or any other suitable non-volatile computer storage device. In some embodiments, the memory 2410 includes both volatile and non-volatile computer storage media.

In some embodiments, the memory 2410 stores data related to location services in NTN. For example, the memory 2410 may store various parameters, panel/beam configurations, resource assignments, policies, and the like as described above. In certain embodiments, the memory 2410 also stores program code and related data, such as an operating system or other controller algorithms operating on the user equipment apparatus 2400.

The input device 2415, in one embodiment, may include any known computer input device including a touch panel, a button, a keyboard, a stylus, a microphone, or the like. In some embodiments, the input device 2415 may be integrated with the output device 2420, for example, as a touchscreen or similar touch-sensitive display. In some embodiments, the input device 2415 includes a touchscreen such that text may be input using a virtual keyboard displayed on the touchscreen and/or by handwriting on the touchscreen. In some embodiments, the input device 2415 includes two or more different devices, such as a keyboard and a touch panel.

The output device 2420, in one embodiment, is designed to output visual, audible, and/or haptic signals. In some embodiments, the output device 2420 includes an electronically controllable display or display device capable of outputting visual data to a user. For example, the output device 2420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 2420 may include a wearable display separate from, but communicatively coupled to, the rest of the user equipment apparatus 2400, such as a smart watch, smart glasses, a heads-up display, or the like. Further, the output device 2420 may be a component of a smart phone, a personal digital assistant, a television, a table computer, a notebook (laptop) computer, a personal computer, a vehicle dashboard, or the like.

In certain embodiments, the output device 2420 includes one or more speakers for producing sound. For example, the output device 2420 may produce an audible alert or notification (e.g., a beep or chime). In some embodiments, the output device 2420 includes one or more haptic devices for producing vibrations, motion, or other haptic feedback. In some embodiments, all or portions of the output device 2420 may be integrated with the input device 2415. For example, the input device 2415 and output device 2420 may form a touchscreen or similar touch-sensitive display. In other embodiments, the output device 2420 may be located near the input device 2415.

The transceiver 2425 communicates with one or more network functions of a mobile communication network via one or more access networks. The transceiver 2425 operates under the control of the processor 2405 to transmit messages, data, and other signals and also to receive messages, data, and other signals. For example, the processor 2405 may selectively activate the transceiver 2425 (or portions thereof) at particular times in order to send and receive messages.

The transceiver 2425 includes at least transmitter 2430 and at least one receiver 2435. One or more transmitters 2430 may be used to provide UL communication signals to a base unit 121, such as the UL transmissions described herein. Similarly, one or more receivers 2435 may be used to receive DL communication signals from the base unit 121, as described herein. Although only one transmitter 2430 and one receiver 2435 are illustrated, the user equipment apparatus 2400 may have any suitable number of transmitters 2430 and receivers 2435. Further, the transmitter(s) 2430 and the receiver(s) 2435 may be any suitable type of transmitters and receivers. In one embodiment, the transceiver 2425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 2425, transmitters 2430, and receivers 2435 may be implemented as physically separate components that access a shared hardware resource and/or software resource, such as for example, the network interface 2440.

In various embodiments, one or more transmitters 2430 and/or one or more receivers 2435 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 2430 and/or one or more receivers 2435 may be implemented and/or integrated into a multi-chip module. In some embodiments, other components such as the network interface 2440 or other hardware components/circuits may be integrated with any number of transmitters 2430 and/or receivers 2435 into a single chip. In such embodiment, the transmitters 2430 and receivers 2435 may be logically configured as a transceiver 2425 that uses one more common control signals or as modular transmitters 2430 and receivers 2435 implemented in the same hardware chip or in a multi-chip module.

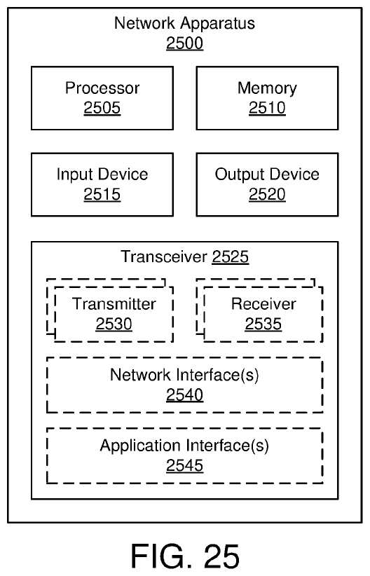

FIG. 25 depicts a network apparatus 2500 that may be used for location services in NTN, according to embodiments of the disclosure. In one embodiment, the network apparatus 2500 may be one implementation of an access network endpoint, such as the base unit 121 and/or RAN node 210, as described above. In another embodiment, the network apparatus 2500 may be one implementation of a location management entity, such as a LMF (such as the LMF 146, the LMF 1730, the LMF 1830, the serving LMF 1910, or the serving LMF 2010), a LMC (such as the LMC node 2205, the LMC node 2305, or a LMC functionality embedded in a gNB and/or satellite), or network entity that provides LCS, as described above. Furthermore, the network apparatus 2500 may include a processor 2505, a memory 2510, an input device 2515, an output device 2520, and a transceiver 2525.

In some embodiments, the input device 2515 and the output device 2520 are combined into a single device, such as a touchscreen. In certain embodiments, the network apparatus 2500 may not include any input device 2515 and/or output device 2520. In various embodiments, the network apparatus 2500 may include one or more of: the processor 2505, the memory 2510, and the transceiver 2525, and may not include the input device 2515 and/or the output device 2520.

As depicted, the transceiver 2525 includes at least one transmitter 2530 and at least one receiver 2535. Here, the transceiver 2525 communicates with one or more remote units 105. Additionally, the transceiver 2525 may support at least one network interface 2540 and/or application interface 2545. The application interface(s) 2545 may support one or more APIs. The network interface(s) 2540 may support 3GPP reference points, such as Uu, N1, N2 and N3. Other network interfaces 2540 may be supported, as understood by one of ordinary skill in the art.

The processor 2505, in one embodiment, may include any known controller capable of executing computer-readable instructions and/or capable of performing logical operations. For example, the processor 2505 may be a microcontroller, a microprocessor, a CPU, a GPU, an auxiliary processing unit, a FPGA, or similar programmable controller. In some embodiments, the processor 2505 executes instructions stored in the memory 2510 to perform the methods and routines described herein. The processor 2505 is communicatively coupled to the memory 2510, the input device 2515, the output device 2520, and the transceiver 2525.

In various embodiments, the network apparatus 2500 is a RAN node (e.g., gNB) that communicates with one or more UEs, as described herein. In such embodiments, the processor 2505 controls the network apparatus 2500 to perform the above-described RAN behaviors. When operating as a RAN node, the processor 2505 may include an application processor (also known as “main processor”) which manages application-domain and operating system (“OS”) functions and a baseband processor (also known as “baseband radio processor”) which manages radio functions.

In various embodiments, the processor 2505 configures a plurality of location services for a UE over an NTN NG-RAN, where the NTN NG-RAN includes at least one satellite and at least one NTN gateway. Moreover, the processor 2505 determines an architecture type of the NTN NG-RAN and determines a target-UE position estimate based on the determined architecture type.

In some embodiments, the architecture type of the NTN NG-RAN includes a transparent NTN system. In other embodiments, the architecture type of the NTN NG-RAN includes a regenerative NTN system. In various embodiments, the processor 2505 is configured to provide at least one high accuracy and low latency location service based on the determined architecture type.

In some embodiments, the apparatus 2500 is a LMC for the NTN NG-RAN, where the processor 2505, as the LMC, provides at least one of the plurality of location services. In one scenario, the LMC may directly configure the target UE independent of the LMF. In another scenario, the LMC may exchange messages with the LMF to configure the target-UE. In a further scenario, the LMC and LMF may jointly configure the target UE.

In certain embodiments, the processor 2505, as the LMC, provides a subset of the functionality provided by the LMF. In some embodiments, via the transceiver 2525, the processor 2505, as the LMC, receives assistance from a LMF in the mobile communication network, the LMF different than the apparatus 2500.

In some embodiments, the apparatus 2500, as the LMC, includes a LMU configured to: A) acquire positioning measurements, B) process the positioning measurements, C) compute the target-UE position estimate, D) request applicable positioning measurements based on supported positioning methods, E) report applicable positioning measurements based on the supported positioning methods, or F) perform a combination thereof. In certain embodiments, the processor 2505 defines a LMC for the NTN NG-RAN, e.g., based on the determined architecture type.

In some embodiments, via the transceiver 2525, the processor 2505 receives an indication of: A) a number of satellites associated with a positioning protocol session (e.g., a LPP session), B) a number of NTN gateways associated with the positioning protocol session, and C) a number of satellites per NTN gateway associated with the positioning protocol session. In such embodiments, the processor 2505 selects at least one positioning method to be employed during the positioning protocol session and selecting a respective measurement associated with each positioning method to be employed during the positioning protocol session.

In certain embodiments, via the transceiver 2525, the processor 2505 configures the UE with the at least one positioning method to be employed and the respective measurement associated with each positioning method to be employed. In certain embodiments, via the transceiver 2525, the processor 2505 configures the NTN NG-RAN with the at least one positioning method to be employed and a measurement associated with each positioning method to be employed.

In some embodiments, the apparatus 2500 includes a serving LMF in the mobile communication network, where the mobile communication network also includes a secondary LMF (e.g., neighboring LMF) communicatively coupled to the UE via the NTN NG-RAN. In such embodiments, via the transceiver 2525, the processor 2505 receives assistance from the secondary LMF to determine a position of the UE.

In some embodiments, the apparatus 2500 is embedded within at least one of the satellite, the NTN gateway, a base station unit, and a roadside unit. In some embodiments, the apparatus 2500 has a functional interface with (i.e., is communicatively coupled to) at least one of the satellite, the NTN gateway, a base station unit, and a roadside unit. In some embodiments, the apparatus 2500 has a functional interface with (i.e., is communicatively coupled to) the UE via multiple satellites and at least one NTN gateway.

In some embodiments, the configured plurality of location services includes a set of location requests supported by an NTN portion of the NTN NG-RAN, where the set of location requests includes: A) a network-induced location request, B) a mobile-terminated location request, C) a mobile-originated location request, D) an immediate location request, E) a deferred location request, or F) a combination thereof.

The memory 2510, in one embodiment, is a computer readable storage medium. In some embodiments, the memory 2510 includes volatile computer storage media. For example, the memory 2510 may include a RAM, including DRAM, SDRAM, and/or SRAM. In some embodiments, the memory 2510 includes non-volatile computer storage media. For example, the memory 2510 may include a hard disk drive, a flash memory, or any other suitable non-volatile computer storage device. In some embodiments, the memory 2510 includes both volatile and non-volatile computer storage media.

In some embodiments, the memory 2510 stores data related to location services in NTN. For example, the memory 2510 may store parameters, configurations, resource assignments, policies, and the like, as described above. In certain embodiments, the memory 2510 also stores program code and related data, such as an operating system or other controller algorithms operating on the network apparatus 2500.

The input device 2515, in one embodiment, may include any known computer input device including a touch panel, a button, a keyboard, a stylus, a microphone, or the like. In some embodiments, the input device 2515 may be integrated with the output device 2520, for example, as a touchscreen or similar touch-sensitive display. In some embodiments, the input device 2515 includes a touchscreen such that text may be input using a virtual keyboard displayed on the touchscreen and/or by handwriting on the touchscreen. In some embodiments, the input device 2515 includes two or more different devices, such as a keyboard and a touch panel.

The output device 2520, in one embodiment, is designed to output visual, audible, and/or haptic signals. In some embodiments, the output device 2520 includes an electronically controllable display or display device capable of outputting visual data to a user. For example, the output device 2520 may include, but is not limited to, an LCD display, an LED display, an OLED display, a projector, or similar display device capable of outputting images, text, or the like to a user. As another, non-limiting, example, the output device 2520 may include a wearable display separate from, but communicatively coupled to, the rest of the network apparatus 2500, such as a smart watch, smart glasses, a heads-up display, or the like. Further, the output device 2520 may be a component of a smart phone, a personal digital assistant, a television, a table computer, a notebook (laptop) computer, a personal computer, a vehicle dashboard, or the like.

In certain embodiments, the output device 2520 includes one or more speakers for producing sound. For example, the output device 2520 may produce an audible alert or notification (e.g., a beep or chime). In some embodiments, the output device 2520 includes one or more haptic devices for producing vibrations, motion, or other haptic feedback. In some embodiments, all or portions of the output device 2520 may be integrated with the input device 2515. For example, the input device 2515 and output device 2520 may form a touchscreen or similar touch-sensitive display. In other embodiments, the output device 2520 may be located near the input device 2515.

The transceiver 2525 includes at least transmitter 2530 and at least one receiver 2535. One or more transmitters 2530 may be used to communicate with the UE, as described herein. Similarly, one or more receivers 2535 may be used to communicate with network functions in the PLMN and/or RAN, as described herein. Although only one transmitter 2530 and one receiver 2535 are illustrated, the network apparatus 2500 may have any suitable number of transmitters 2530 and receivers 2535. Further, the transmitter(s) 2530 and the receiver(s) 2535 may be any suitable type of transmitters and receivers.

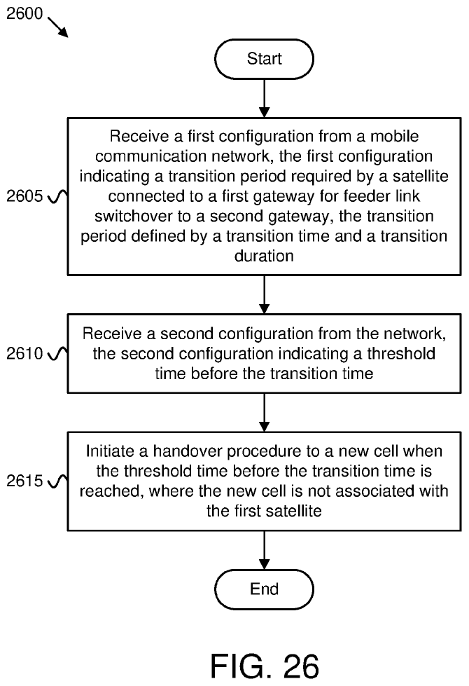

FIG. 26 depicts one embodiment of a method 2600 for location services in NTN, according to embodiments of the disclosure. In various embodiments, the method 2600 is performed by a location management entity, such as a LMF (such as the LMF 146, the LMF 1730, the LMF 1830, the serving LMF 1910, or the serving LMF 2010), a LMC (such as the LMC node 2205, the LMC node 2305, or a LMC functionality embedded in a gNB and/or satellite), or network entity that provides LCS, and/or the network apparatus 2500, described above. In some embodiments, the method 2600 is performed by a processor, such as a microcontroller, a microprocessor, a CPU, a GPU, an auxiliary processing unit, a FPGA, or the like.

The method 2600 includes configuring 2605 a plurality of location services for a UE over an NTN NG-RAN that comprises at least one satellite and at least one NTN gateway. The method 2600 includes determining 2610 an architecture type of the NTN NG-RAN. The method 2600 includes determining 2615 a target-UE position estimate based on the determined architecture type. The method 2600 ends.

Disclosed herein is a first method for location services in NTN, according to embodiments of the disclosure. The first method may be performed by a location management entity, such as a LMF (such as the LMF 146, the LMF 1730, the LMF 1830, the serving LMF 1910, or the serving LMF 2010), a LMC (such as the LMC node 2205, the LMC node 2305, or a LMC functionality embedded in a gNB and/or satellite), and/or the network apparatus 2500, as described above. The first method includes configuring a plurality of location services for a UE over an NTN NG-RAN that includes at least one satellite and at least one NTN gateway. The first method includes determining an architecture type of the NTN NG-RAN and determining a target-UE position estimate based on the determined architecture type.

In some embodiments, the architecture type of the NTN NG-RAN includes a transparent NTN system. In other embodiments, the architecture type of the NTN NG-RAN includes a regenerative NTN system. In various embodiments, the first method includes providing at least one high accuracy and low latency location service based on the determined architecture type.

In some embodiments, the network entity includes a LMC for NTN NG-RAN, where the LMC configures and provides at least one of the plurality of location services. In certain embodiments, the LMC provides a subset of the functionality provided by the LMF. In certain embodiments, the first method includes defining the LMC for the NTN NG-RAN based on the determined architecture type. In some embodiments, the first method includes receiving assistance from a LMF in the mobile communication network, the LMF different than the LMC.

In some embodiments, the LMC includes a LMU configured to: A) acquire positioning measurements, B) process the positioning measurements, C) compute the target-UE position estimate, D) request applicable positioning measurements based on supported positioning methods, E) report applicable positioning measurements based on the supported positioning methods, or F) perform a combination thereof.

In some embodiments, the first method further includes receiving an indication of: A) a number of satellites associated with a positioning protocol session (e.g., a LPP session), B) a number of NTN gateways associated with the positioning protocol session, and C) a number of satellites per NTN gateway associated with the positioning protocol session. In such embodiments, the first method also includes selecting at least one positioning method to be employed during the positioning protocol session and selecting a respective measurement associated with each positioning method to be employed during the positioning protocol session.

In certain embodiments, the first method includes configuring the UE with the at least one positioning method to be employed and the respective measurement associated with each positioning method to be employed. In certain embodiments, the first method includes configuring the NTN NG-RAN with the at least one positioning method to be employed and a measurement associated with each positioning method to be employed.

In some embodiments, the network entity includes a serving LMF in the mobile communication network, where the mobile communication network also includes a secondary LMF (e.g., neighboring LMF) communicatively coupled to the UE via the NTN NG-RAN. In such embodiments, the first method further includes receiving assistance from the secondary LMF to determine a position of the UE.

In some embodiments, the network entity is embedded within at least one of the satellite, the NTN gateway, a base station unit, and a roadside unit. In some embodiments, the network entity has a functional interface with (i.e., is communicatively coupled to) at least one of the satellite, the NTN gateway, a base station unit, and a roadside unit. In some embodiments, the network entity is communicatively coupled to the UE via multiple satellites and at least one NTN gateway.

In some embodiments, the configured plurality of location services includes a set of location requests supported by an NTN portion of the NTN NG-RAN, where the set of location requests includes: A) a network-induced location request, B) a mobile-terminated location request, C) a mobile-originated location request, D) an immediate location request, E) a deferred location request, or F) a combination thereof.

Disclosed herein is a first apparatus for location services in NTN, according to embodiments of the disclosure. The first apparatus may be implemented by a location management entity, such as a LMF (such as the LMF 146, the LMF 1730, the LMF 1830, the serving LMF 1910, or the serving LMF 2010), a LMC (such as the LMC node 2205, the LMC node 2305, or a LMC functionality embedded in a gNB and/or satellite), and/or the network apparatus 2500, as described above. The first apparatus includes a processor coupled to a transceiver, the transceiver configured to communicate with a UE and the processor configured to cause the first apparatus to: A) configure a plurality of location services to a UE over a NTN NG-RAN, the NTN NG-RAN including at least one satellite and at least one NTN gateway; B) determine an architecture type of the NTN NG-RAN; C) select at least one positioning method to be employed based on the determined architecture type; D) select a measurement associated with each positioning method to be employed; and E) configure at least one network node with the at least one positioning method to be employed and the respective measurement associated with each positioning method to be employed, the network node being one of a UE or an NTN NG-RAN node; and F) determine a target-UE position estimate based on the determined architecture type.

In some embodiments, the architecture type of the NTN NG-RAN includes a transparent NTN system. In other embodiments, the architecture type of the NTN NG-RAN includes a regenerative NTN system. In various embodiments, the first apparatus is configured to provide at least one high accuracy and low latency location service based on the determined architecture type.

In some embodiments, the first apparatus includes a LMC for NTN NG-RAN, where the LMC configures and provides at least one of the plurality of location services. In certain embodiments, the LMC provides a subset of the functionality provided by the LMF. In certain embodiments, the processor is further configured to cause the first apparatus to define the LMC for the NTN NG-RAN based on the determined architecture type. In some embodiments, the processor is further configured to cause the first apparatus to receive assistance from a LMF in a mobile communication network, the LMF different than the first apparatus.

In certain embodiments, the LMC includes a LMU configured to: A) acquire positioning measurements, B) process the positioning measurements, C) compute the target-UE position estimate, D) request applicable positioning measurements based on supported positioning methods, E) report applicable positioning measurements based on the supported positioning methods, or F) a combination thereof.

In some embodiments, the processor is further configured to cause the first apparatus to receive an indication of: A) a number of satellites associated with a positioning protocol session (e.g., a LPP session), B) a number of NTN gateways associated with the positioning protocol session, and C) a number of satellites per NTN gateway associated with the positioning protocol session, where the at least one positioning method and the respective measurement associated with each positioning method are selected based on the received indication.

In certain embodiments, the first apparatus includes a serving LMF in a mobile communication network, where the mobile communication network further includes a secondary LMF (e.g., a neighboring LMF) communicatively coupled to the UE via the NTN NG-RAN. In such embodiments, the processor is further configured to cause the first apparatus to receive assistance from the secondary LMF to determine a position of the UE.

In some embodiments, the first apparatus is embedded within at least one of the satellite, the NTN gateway, a base station unit, and a roadside unit. In some embodiments, the first apparatus has a functional interface with (i.e., is communicatively coupled to) at least one of the satellite, the NTN gateway, a base station unit, and a roadside unit. In some embodiments, the first apparatus is communicatively coupled to the UE via multiple satellites and at least one NTN gateway.

In some embodiments, the configured plurality of location services includes a set of location requests supported by an NTN portion of the NTN NG-RAN, where the set of location requests includes: A) a network-induced location request, B) a mobile-terminated location request, C) a mobile-originated location request, D) an immediate location request, E) a deferred location request, or F) a combination thereof.

Disclosed herein is a first system for location services in NTN, according to embodiments of the disclosure. The first system includes a UE (e.g., the remote unit 105 and/or UE 205) configured with a plurality of location services, an NTN NG-RAN (e.g., RAN 120) configured to serve the UE, where the NTN NG-RAN includes at least one satellite and at least one NTN gateway, and a location management entity (e.g., LMF 146 and/or LMC) communicatively coupled to the UE and NTN NG-RAN. Here, the location management entity is configured to: A) determine an architecture type of the NTN NG-RAN; B) provide at least one high accuracy and low latency location service based on the determined architecture type; and C) determine a target-UE position estimate based on the determined architecture type.

In some embodiments, the architecture type of the NTN NG-RAN includes a transparent NTN system. In other embodiments, the architecture type of the NTN NG-RAN includes a regenerative NTN system. In various embodiments, the first method includes providing at least one high accuracy and low latency location service based on the determined architecture type.

In some embodiments, the location management entity includes a LMC for the NTN NG-RAN. In certain embodiments, the LMC provides a subset of the functionality provided by the LMF. In some embodiments, the location management entity is configured to receive assistance from a LMF in a mobile communication network, the LMF different than the LMC.

In certain embodiments, the LMC includes a LMU configured to: A) acquire positioning measurements, B) process the positioning measurements, C) compute the target-UE position estimate, D) request applicable positioning measurements based on supported positioning methods, E) report applicable positioning measurements based on the supported positioning methods, or F) perform a combination thereof.

In some embodiments, the location management entity is configured to receive an indication of: A) a number of satellites associated with a positioning protocol session (e.g., a LPP session), B) a number of NTN gateways associated with the positioning protocol session, and C) a number of satellites per NTN gateway associated with the positioning protocol session. In such embodiments, the location management entity is further configured to select at least one positioning method to be employed during the positioning protocol session and to select a respective measurement associated with each positioning method to be employed during the positioning protocol session.

In certain embodiments, the location management entity configures the UE with the at least one positioning method to be employed and the respective measurement associated with each positioning method to be employed. In certain embodiments, the location management entity configures the NTN NG-RAN with the at least one positioning method to be employed and a measurement associated with each positioning method to be employed.

In some embodiments, the location management entity includes a serving LMF in a mobile communication network, where the mobile communication network further includes a secondary LMF (e.g., a neighboring LMF) communicatively coupled to the UE via the NTN NG-RAN. In such embodiments, the location management entity is further configured to receive assistance from the secondary LMF to determine a position of the UE.

In some embodiments, the location management entity is embedded within at least one of the satellite, the NTN gateway, a base station unit, and a roadside unit. In some embodiments, the location management entity has a functional interface with (i.e., is communicatively coupled to) at least one of the satellite, the NTN gateway, a base station unit, and a roadside unit. In some embodiments, the location management entity is communicatively coupled to the UE via multiple satellites and at least one NTN gateway.

In some embodiments, the configured plurality of location services includes a set of location requests supported by an NTN portion of the NTN NG-RAN, where the set of location requests includes: A) a network-induced location request, B) a mobile-terminated location request, C) a mobile-originated location request, D) an immediate location request, E) a deferred location request, or F) a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a network entity, comprising:
configuring a plurality of location services for a user equipment (“UE”) over a non-terrestrial network (“NTN”) next generation-radio access network (“NG-RAN”), the NTN NG-RAN comprising at least one satellite and at least one NTN gateway;
determining an architecture type of the NTN NG-RAN; and
determining a target-UE position estimate based on the determined architecture type.

2. The method of claim 1, wherein the architecture type of the NTN NG-RAN comprises either a transparent NTN system or a regenerative NTN system.

3. The method of claim 1, wherein the network entity comprises a location management function (“LMC”) for the NTN NG-RAN, wherein the LMC configures and provides at least one of the plurality of location services.

4. The method of claim 3, wherein the LMC comprises a Location Measurement Unit (“LMU”) configured to:
acquire positioning measurements,
process the positioning measurements,
compute the target-UE position estimate,
request applicable positioning measurements based on supported positioning methods,
report applicable positioning measurements based on the supported positioning methods,
or perform a combination thereof.

5. The method of claim 1, further comprising
receiving an indication of:
a number of satellites associated with a positioning protocol session,
a number of NTN gateways associated with the positioning protocol session, and
a number of satellites per NTN gateway associated with the positioning protocol session,
selecting at least one positioning method to be employed during the positioning protocol session, and
selecting a respective measurement associated with each positioning method to be employed during the positioning protocol session.

6. The method of claim 5, further comprising configuring the UE with the at least one positioning method to be employed and the respective measurement associated with each positioning method to be employed.

7. The method of claim 5, further comprising configuring the NTN NG-RAN with the at least one positioning method to be employed and a measurement associated with each positioning method to be employed.

8. The method of claim 1, wherein the network entity comprises a serving Location Management Function (“LMF”) in a mobile communication network, wherein the mobile communication network further comprises a secondary LMF communicatively coupled to the UE via the NTN NG-RAN, the method further comprising receiving assistance from the secondary LMF to determine a position of the UE.

9. The method of claim 1, further comprising receiving assistance from a Location Management Function (“LMF”) in a mobile communication network.

10. The method of claim 1, wherein the network entity is embedded within at least one of the satellite, the NTN gateway, a base station unit, and a roadside unit.

11. The method of claim 1, wherein the network entity has a functional interface with at least one of the satellite, the NTN gateway, a base station unit, and a roadside unit.

12. The method of claim 1, wherein the network entity is communicatively coupled to the UE via multiple satellites and at least one NTN gateway.

13. The method of claim 1, wherein the configured plurality of location services comprises a set of location requests supported by an NTN portion of the NTN NG-RAN, wherein the set of location requests comprises:
a network-induced location request,
a mobile-terminated location request,
a mobile-originated location request,
an immediate location request,
a deferred location request,
or a combination thereof.

14. A system comprising:
a user equipment (“UE”) configured with a plurality of location services;
a non-terrestrial network (“NTN”) next generation-radio access network (“NG-RAN”) configured to serve the UE, wherein the NTN NG-RAN comprises at least one satellite and at least one NTN gateway; and
a location management entity communicatively coupled to the UE and NTN NG-RAN, the location management entity configured to:
determine an architecture type of the NTN NG-RAN; and
determine a target-UE position estimate based on the determined architecture type.

15. An apparatus comprising:
a processor; and
a memory coupled to the processor, the processor configured to cause the apparatus to:
configure a plurality of location services to a user equipment (“UE”) over a non-terrestrial network (“NTN”) next generation-radio access network (“NG-RAN”), the NTN NG-RAN comprising at least one satellite and at least one NTN gateway;
determine an architecture type of the NTN NG-RAN;
select at least one positioning method to be employed based on the determined architecture type;
select a measurement associated with each positioning method to be employed;
configure at least one network node with the at least one positioning method to be employed and the respective measurement associated with each positioning method to be employed, the network node being one of a UE or an NTN NG-RAN node; and
determine a target-UE position estimate based on the determined architecture type.
